(19) United States
(12) Patent Application Publication
(10) Pub. No.: US 2026/0212039 A1
(43) Pub. Date: Jul. 23, 2026

(54) LOW-LATENCY SAFETY FRAMEWORK FOR AGENTIC ARTIFICIAL INTELLIGENCE SYSTEMS

(71) Applicant: Oracle International Corporation, Redwood Shores, CA (US)

(72) Inventors: Huy Viet Nguyen, Issaquah, WA (US); Krishnaram Kenthapadi, Sunnyvale, CA (US); Alexander Mark Hellkamp, Woodinville, WA (US); Aashna Devang Kanuga, Foster City, CA (US); Xin Xu, San Jose, CA (US)

(73) Assignee: Oracle International Corporation, Redwood Shores, CA (US)

(21) Appl. No.: 19/450,003

(22) Filed: Jan. 15, 2026

Related U.S. Application Data
(60) Provisional application No. 63/748,665, filed on Jan. 23, 2025.

(51) Int. Cl. G06F 21/62

(52) U.S. Cl. CPC G06F 21/6227

(57) ABSTRACT

Techniques disclosed herein pertain to agentic artificial intelligence (AI) systems, and, more specifically, to safety mechanisms for agentic AI systems. A query is accessed, and, in response to accessing the query, a planning process to generate an execution plan for responding to the query and a safety analysis process to determine a safety classification for the query based on a set of policies can be initiated. A determination can be made as to whether to authorize execution of the execution plan based on the safety classification from the safety analysis process. In response to determining to authorize execution of the execution plan, the execution plan can be executed and a substantive response to the query can be generated based on the execution. In response to determining not to authorize execution of the execution plan, execution of the execution plan can be blocked and a fallback response can be generated.

### CROSS-REFERENCE TO RELATED APPLICATION

This application claims priority to U.S. Provisional Application No. 63/748,665, filed on Jan. 23, 2025, the disclosure of which is incorporated herein by reference in its entirety for all purposes.

### FIELD

The present disclosure relates generally to agentic artificial intelligence (AI) systems, and, more specifically, to safety mechanisms for agentic AI systems.

### BACKGROUND

Developments in artificial intelligence (AI) have led to the creation of sophisticated agentic AI systems. These systems may be configured to understand natural language and perform complex tasks, making them suitable for deployment in various specialized and sensitive domains. In environments that handle confidential or proprietary information, for instance, these agentic systems may incorporate safety frameworks. A safety framework may monitor the behavior of an underlying artificial intelligence model to promote the alignment of inputs and outputs with organizational or regulatory policies. The operational effectiveness of such systems can be influenced by multiple factors, including the performance overhead of the safety framework and its ability to process information within the specific context of its deployment domain. Maintaining a real-time, interactive user experience and ensuring high-accuracy, contextually aware responses are considerations in the design and implementation of agentic AI systems.

### BRIEF SUMMARY

Techniques disclosed herein pertain to agentic artificial intelligence (AI) systems, and, more specifically, to safety mechanisms for agentic AI systems.

In some embodiments, a computer-implemented method includes: accessing a query; in response to accessing the query, initiating: a planning process to generate an execution plan for responding to the query; and a safety analysis process to determine a safety classification for the query based on a set of policies; determining, based on the safety classification from the safety analysis process, whether to authorize execution of the execution plan; and in response to determining to authorize execution of the execution plan, executing the execution plan and generating a substantive response for the query based on execution of the execution plan.

In some embodiments, the planning process and the safety analysis process are initiated to run concurrently.

In some embodiments, the computer-implemented method further includes: in response to determining not to authorize execution of the execution plan, blocking the execution of the execution plan and generating a fallback response.

In some embodiments, the fallback response is a templated response indicating that the query cannot be processed.

In some embodiments, the safety analysis process determines the safety classification by applying the set of policies in a hierarchical order.

In some embodiments, the hierarchical order comprises assessing whether the query is unethical prior to assessing whether the query is unsafe, and assessing whether the query is unsafe prior to assessing whether the query is out-of-domain.

In some embodiments, the set of policies corresponds to a predetermined operational domain, and wherein the safety classification is determined based on an interpretation of the query within a context of the predetermined operational domain.

In some embodiments, the execution plan comprises at least one step for retrieving data from a confidential data source, and wherein blocking the execution of the execution plan prevents the at least one step from being performed.

In some embodiments, generating the substantive response comprises generating a stream of data packets.

In some embodiments, generating the substantive response comprises performing a first output safety check on at least one data packet of the stream of data packets as the stream of data packets is being generated, a second output safety check on the stream of data packets after the stream of data packets have been generated, or a combination thereof.

In some embodiments, a confidence score associated with the safety classification from the safety analysis process is used to modulate a policy of the first output safety check or the second output safety check.

In some embodiments, the safety analysis process includes: generating a prompt for a machine learning model, the prompt including the query and the set of policies; and receiving, from the machine learning model, the safety classification for the query based on an evaluation of the query against the set of policies included in the prompt.

In some embodiments, the set of policies corresponds to a clinical operational domain, and wherein the set of policies includes rules for identifying unethical queries relating to at least one of: fraudulent billing, patient data misuse, or discrimination in care.

Some embodiments include a system that includes one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a digital assistant system in accordance with various embodiments.

FIG. 2 is an example of a user interface for configuring an agent of a digital assistant in accordance with various embodiments.

FIG. 3 is an example of a computing environment involving a digital assistant that can be implemented with generative artificial intelligence in accordance with various embodiments.

FIG. 4 is a simplified block diagram of a computing environment including a digital assistant that can execute an execution plan for responding to a query in accordance with various embodiments.

FIG. 5 is a simplified diagram of an example environment for providing a clinical artificial intelligence agent, according to certain embodiments.

FIG. 6 is a simplified diagram of another example environment for providing a clinical artificial intelligence agent, according to certain embodiments.

FIG. 7 is a simplified diagram of another example environment for providing a clinical artificial intelligence agent, according to certain embodiments.

FIG. 8 shows a simplified diagram of an example data flow illustrating a multi-level intervention architecture for a conversational artificial intelligence assistant, according to certain embodiments.

FIG. 9 shows a simplified flowchart of an example workflow for a guardrail component, according to certain embodiments.

FIG. 10 shows a simplified block diagram of an example architecture for an agentic AI system that includes a low-latency safety framework, according to certain embodiments.

FIG. 11 is a block diagram illustrating operational aspects of a parallel execution planner of an agentic AI system, according to certain embodiments.

FIG. 12 shows a simplified block diagram of an example architecture for a response engine that includes a guardrail framework, according to certain embodiments.

FIG. 13 depicts an example of a process for providing a low-latency safety framework for an agentic AI system, according to certain embodiments.

FIG. 14 is a block diagram illustrating one pattern for implementing a cloud infrastructure as a service system according to certain embodiments.

FIG. 15 is a block diagram illustrating another pattern for implementing a cloud infrastructure as a service system according to certain embodiments.

FIG. 16 is a block diagram illustrating another pattern for implementing a cloud infrastructure as a service system according to certain embodiments.

FIG. 17 is a block diagram illustrating another pattern for implementing a cloud infrastructure as a service system according to certain embodiments.

FIG. 18 is a block diagram illustrating an example computer system according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Agentic Digital Assistant

Artificial intelligence techniques have broad applicability. For example, a digital assistant can be or include an artificial-intelligence-driven interface that helps users accomplish a variety of tasks using natural language conversations. For conventional digital assistants, such as those that do not involve generative artificial intelligence, a provider of the digital assistant may assemble one or more skills that can be focused on specific types of tasks such as tracking inventory, submitting timecards, and creating expense reports. When an end user engages with the digital assistant, the digital assistant can evaluate input provided by the end user to determine the intent of the end user and can route the conversation to and from the appropriate skill based on a perceived intent of the end user. However, there are some disadvantages of traditional intent-based skills including a limited understanding of natural language, inability to handle unknown inputs, limited ability to hold natural conversations off script, challenges integrating external knowledge, and the like.

User interactions with a digital assistant can lead to prompt responses to queries or the execution of requested actions. Additionally, these interactions have the potential to emulate human-like conversations, resembling a natural back-and-forth dialogue between a user and a human operator. To enhance user experience, digital assistants may also engage in multimodal communications, allowing users to convey information through spoken utterances or alternative input methods, such as selecting options on a computer display. However, achieving such functionalities efficiently with digital assistants, especially through natural language models, poses several challenges. For instance, understanding human speech remains a significant hurdle for natural language models, even those based on machine-learning. The scalability of the models can be problematic and inefficient, while their domain-specific limitations further complicate effective communication in various contexts.

The advent of generative artificial intelligence techniques and models, such as large language models (LLMs), has propelled the field of digital assistant design to unprecedented levels of sophistication and can be used to address the above and other technical problems associated with traditional intent-based skills. An LLM can be or include a neural network that employs a transformer architecture, which is specifically generated for processing and generating sequential data such as text or words in conversations. LLMs can undergo training with extensive textual data, and the training can gradually hone an ability to generate text that closely mimics human-written or spoken language.

Techniques are described herein to enhance LLMs with tools that empower or otherwise provide the LLMs access to external knowledge sources that provide the LLMs with the capability to recall facts and/or knowledge and facilitate the LLMs to better understand and respond to user queries in a contextually relevant manner. These tools, referred to herein as “agents,” provide the capability to recall facts and/or knowledge utilizing various techniques such as knowledge graphs, custom knowledge bases, Application Programming Interfaces (APIs), web crawling or scraping, and the like. In some examples, the tools, or the agents, can be powered or otherwise controlled by the LLMs. Once configured, the LLMs and agents can be deployed in artificial intelligence-based systems such as digital assistant applications. Users, such as end users or other entities, can interact with the digital assistant, such as by posing questions or making requests, and the LLMs and agents can work in tandem to generate responses based on a combination of a base LLM capability and access to the external knowledge via the agent. Using the LLMs and agents allows the digital assistant to provide more accurate, relevant, and contextually appropriate responses across a wide range of applications and domains.

For each digital assistant, a user (e.g., developer) may assemble LLMs and agents that interact to provide human-like conversation capabilities for various types of tasks such as tracking inventory, submitting timecards, updating accounts, creating expense reports, and the like. The LLMs are machine learning models trained on various tasks including plan creation using the LLM's in-context learning capability, knowledge or information retrieval on behalf of an agent, response generation to facilitate the human-like conversation, or any combination thereof. The agents are essentially containers having a software package containing everything needed to execute one or more actions defined for the agents. For example, the software package may include the code and any runtime configurations the code requires, application and system libraries, default values for any settings, and the like. The configuration parameters, settings, and customizations for dialog and routing/reasoning are primarily defined using natural language by a user (e.g., a developer). For example, users can provide configuration parameters that connect the agent to external assets, such as APIs, knowledge-based assets such as documents, URLs, LLMs, images, etc., data stores, prior conversations, etc. for executing one or more actions (e.g., change a user's 401k contribution). Once an agent is created, flow confirmation and testing may be performed through simulated conversations with LLMs and agents, and a digital assistant can then be implemented.

Implementation of an LLM-based digital assistant generally involves receiving a user input, such as a verbal request, command, or other statement (e.g., an utterance) from which the LLM digital assistant has a high-level awareness of the goal of the end user. A list of candidate agents is then determined based on the user input. The list of candidate agents includes agents configured to perform one or more actions that may potentially facilitate a response to the user input. Metadata for the agents in the list of candidate agents is then combined with the user input to construct an input prompt for an LLM. The LLM generates an execution plan that includes actions for facilitating a response to the user input based on the input prompt and metadata. The execution plan is then executed by an execution engine, which causes the agents to execute the actions. The actions may include internal task mapping in which a given action can be mapped to an API or semantic search knowledge task type. The execution of the actions generates output data from various sources, such as knowledge, API, SQL operations, etc., and/or relevant context and memory information from a context and memory store. The output data and relevant context and memory information are then combined with the user input to construct an output prompt for an LLM. The LLM synthesizes a response to the user input based on the output data and relevant context and memory information, and user input. The response is then sent to the user as an individual response or as part of a conversation with the user.

Advantageously, the LLM-based digital assistant described herein leverages reasoning capabilities of LLMs to drive decision-making and action orchestration to recall facts and/or knowledge and to facilitate the LLMs to better understand and respond to user queries in a contextually relevant manner. Additionally, or alternatively, the LLM-based digital assistant can eliminate a need for scripted dialog flows and provide out-of-the-box, human-like conversation capabilities.

A digital assistant can be or include a computer program that can perform conversations with end users. The digital assistant can generally respond to natural-language messages, such as questions and/or comments, through a messaging application (referred to herein as channels) that uses natural-language messages. The digital assistant can be made available to end users through a variety of channels, as well as via an application interface that may be developed to include a digital assistant, for example using a digital assistant software development kit. The channels may be or include an end-user-preferred messaging application that the end user has already installed and with which the end user may already be familiar. In some examples, the end user may not need to download and install new applications in order to converse with the digital assistant system. The channels may include, for example, over-the-top (OTT) messaging channels, such as Facebook™ Messenger, Facebook™ WhatsApp™, WeChat™, Line, Kik™, Telegram™, Talk, Skype™, Slack™, or SMS), virtual private assistants (such as Amazon™ Dot, Echo, or Show, Google™ Home, Apple™ HomePod™, etc.), mobile and web app extensions that extend native or hybrid/responsive mobile apps or web applications with chat capabilities, or voice based input such as devices or apps with interfaces that use Siri™, Cortana™, Google™ Voice, or other speech input for interaction.

The channels can carry the chat back and forth from end users to the digital assistant and various LLMs associated with the digital assistant. During the back-and-forth exchanges, the LLMs can receive the processed input in the form of a query and can process the query to generate a response. An LLM can predict the most contextually relevant and grammatically correct response based on training data used to train the LLM and based on received input such as the query and actions executed by the agents. The generated response may undergo post-processing to ensure adherence to guidelines, policies, and formatting standards associated with the digital assistant. This post-processed response may be more coherent and user-friendly than other responses that do not undergo post-processing. The post-processed response can be delivered to the user through the appropriate channel, which may be or include a text-based chat interface, a voice-based system, or another medium. According to various embodiments, the digital assistant can maintain the conversation context, allowing for further interactions and dynamic back-and-forth exchanges between the user and the LLMs where later interactions can build upon earlier interactions.

In some embodiments, the digital assistant system may intelligently handle end user interactions without interaction with a provider, such as an administrator or developer, of the digital assistant system. For example, an end user may send one or more messages to the digital assistant system in order to achieve a desired goal. A message may include certain content, such as text, emojis, audio, image, video, or other method of conveying a message. In some embodiments, the digital assistant system may convert the content into a standardized form, such as a representational state transfer (REST) or API call, against enterprise services with the proper parameters, and generate a natural language response. The digital assistant system may also prompt the end user for additional input parameters or request other additional information. In some embodiments, the digital assistant system may also initiate communication with the end user, rather than passively responding to end user utterances. Various techniques can be used for identifying an explicit invocation of a digital assistant system and determining an input for the digital assistant system being invoked. In certain embodiments, explicit invocation analysis can be performed by a primary digital assistant based at least in part on detecting an invocation name in an utterance. In response to detecting the invocation name, the utterance may be refined or pre-processed for input to a digital assistant that is identified to be associated with the invocation name and/or communication.

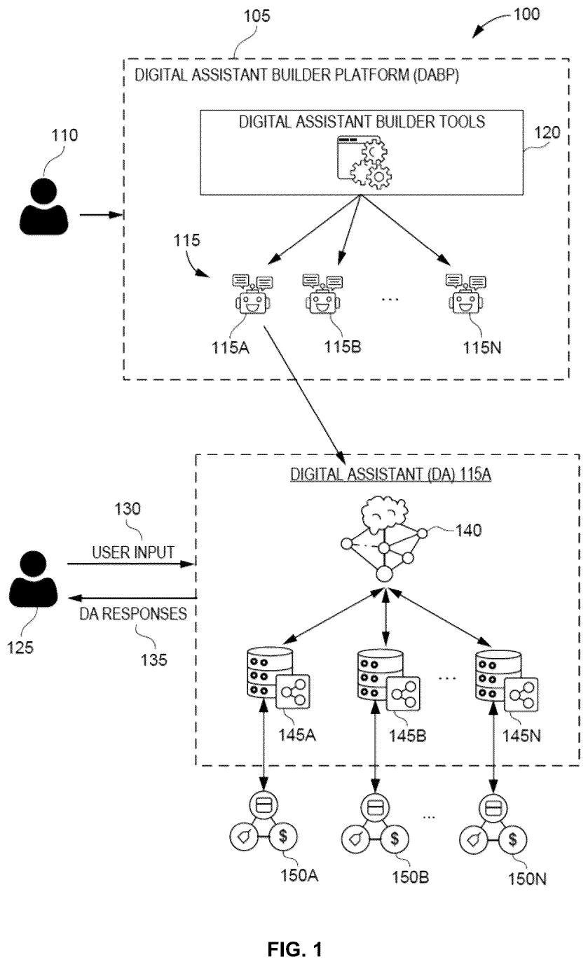

FIG. 1 is a simplified block diagram of an environment 100 incorporating a digital assistant system according to certain embodiments. Environment 100 includes a digital assistant builder platform (DABP) 105 that enables users 110 to create and deploy digital assistant systems 115. For purposes of this disclosure, a “digital assistant” is an entity that helps users of the digital assistant accomplish various tasks through natural language conversations. A digital assistant can be implemented using software only (e.g., the digital assistant is a digital entity implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistants (or DAs) systems. For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

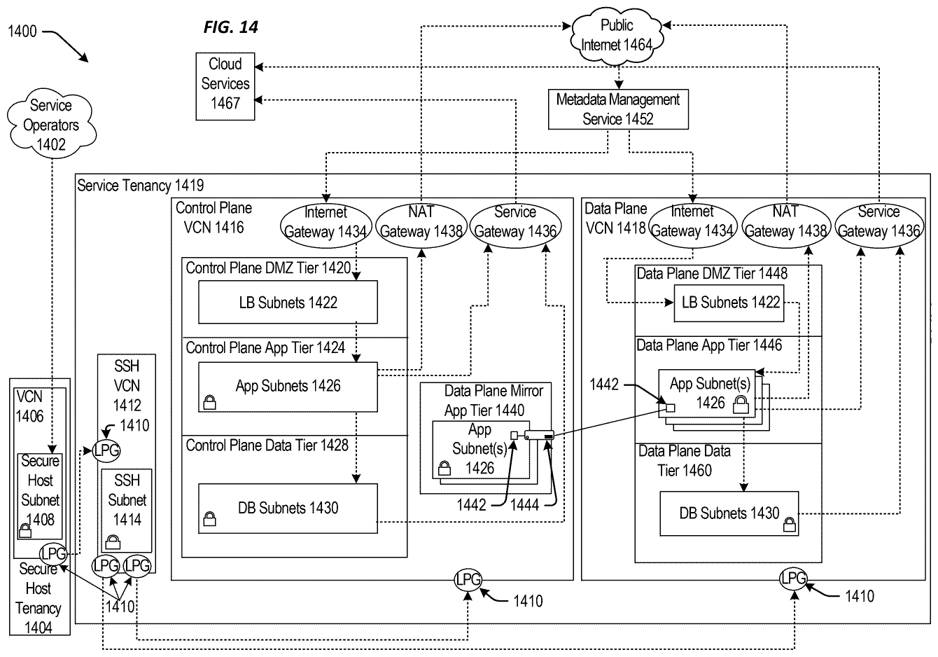

To create one or more digital assistant systems 115, the DABP 105 is equipped with a suite of tools 140, enabling the acquisition of LLMs, agent creation, asset identification, and deployment of digital assistant systems within a service architecture (described herein in detail with respect to FIG. 1) for users via a computing platform such as a cloud computing platform described in detail with respect to FIGS. 14-18. In some instances, the tools 140 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 140 can be utilized to pre-train and/or fine-tune the LLMs. The tools 140, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 140 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

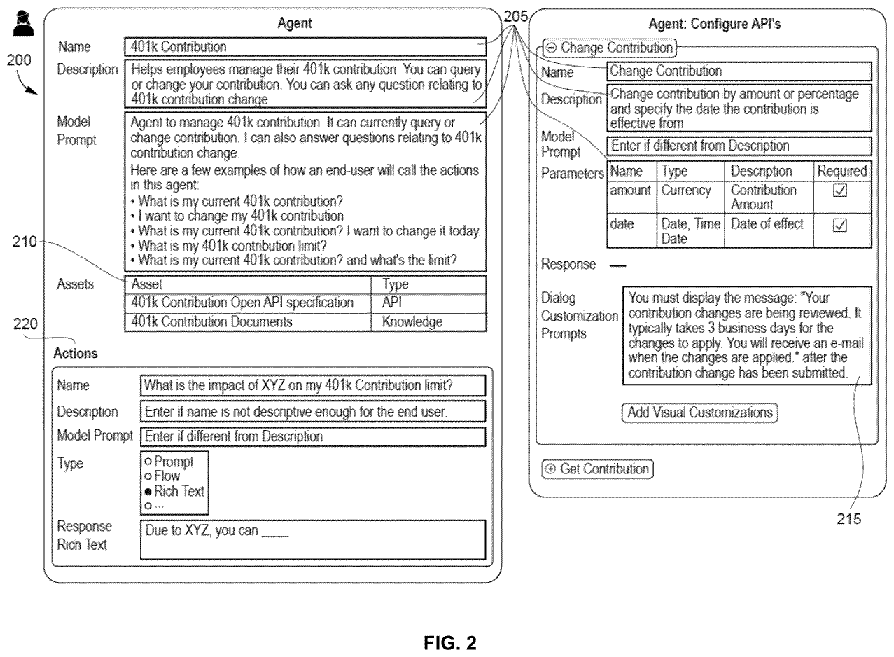

The tools 140 further include a prompt-based agent composition unit for creating agents and their associated actions (e.g., a prompt such as Tell me a joke, implicit Change Contribution, and Get Contribution API calls) that an end-user can end up invoking. As shown in FIG. 2, the agents (e.g., 401k Change Contribution Agent 200) are primarily defined as a compilation of agent artifacts 205 using natural language within the prompt-based agent composition unit. Users 110 can create functional agents quickly by providing agent artifact 205 information, parameters, and configurations and by pointing to assets 210. The assets 210 are resources such as APIs for interfacing with applications, files and/or documents for retrieving knowledge, data stores for interacting with data, and the like available to the agents for the execution of actions. The assets 210 are imported, and then the users 110 can use natural language again to provide additional API customizations for dialog and routing/reasoning 215. Most of what an agent does involves executing actions 220. An action 220 can be an explicit one that's authored using natural language (similar to creating agent artifacts—e.g., ‘What is the impact of XYZ on my 401k Contribution limit?’ action in the below ‘401k Contribution Agent’ figure) or an implicit one that is created when an asset is imported (automatically imported upon pointing to a given asset based on metadata and/or specifications associated with the asset—e.g., actions created for Change Contribution and Get Contribution API in the below ‘401k Contribution Agent’ figure). In the agent example illustrated in FIG. 2, the design time user can easily create explicit actions. For example, the user chooses the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets 210) the agent references (thus was not implicitly added as an action). Exemplary action types that can be authored are described in Table 1 below.

TABLE 1

| | Action | |
|---|---|---|
| | Type | Description |
| 1 | Prompt | The action is implemented using a prompt to an LLM. |
| 2 | Rich | The action is implemented using rich text. The most |
| | Text | common use case is FAQs. |
| 3 | Flow | The action is implemented using Visual Flow Designer |
| | | flow. May be used for complex cases where the developer |
| | | is not able to use the out-of-the-box dialogue and dialog |
| | | customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 140, select specific assets for an agent, initiate a few mock chat conversations with the agent, and indicate that the agent is to be added to the digital assistant created using DABP 105.

Once deployed in a production environment, such as the architecture described with respect to FIG. 1, a digital assistant, such as digital assistant 115A built using DABP 105, can be used to perform various tasks via natural language-based conversations between the digital assistant 115A and its users 145. As described above, the digital assistant 115A illustrated in FIG. 1 can be made available or accessible to its users 145 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 145 may provide one or more user inputs 130 to digital assistant 115A and get responses 135 back from digital assistant 115A. A conversation can include one or more user inputs 130 and responses 135. Via these conversations, a user 145 can request one or more tasks to be performed by the digital assistant 115A and, in response, the digital assistant 115A is configured to perform the user-requested tasks and respond with appropriate responses to the user 145 using one or more LLMs 140.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 145. For example, the user inputs 130 may be in English, or some other language. When a user inputs 130 is in speech form, the speech input is converted to text form user inputs 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 145 of digital assistant 115A or are the results of conversion of input speech utterances to text form. This, however, is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 145 as an individual response or as part of a conversation with the user 145.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, size, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 145 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems and subsystems as described in greater detail with respect to FIG. 1) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

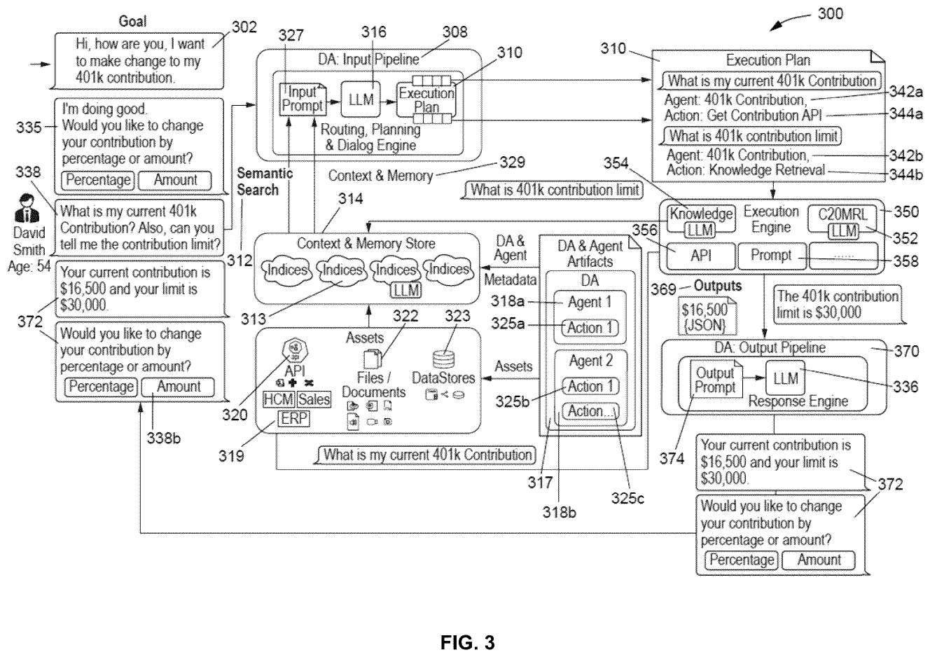

FIG. 3 is an example of an architecture for a computing environment 300 for a digital assistant implemented with generative artificial intelligence in accordance with various embodiments. As illustrated in FIG. 3, an infrastructure and various services and features can be used to enable a user to interact with a digital assistant (e.g., digital assistant 115A described with respect to FIG. 1) based at least in part on a series of prompts such as a conversation. The following is a detailed walkthrough of a conversation flow and the role and responsibility of the components, services, models, and the like of the computing environment 300 within the conversation flow. In this walkthrough, it is assumed that a user “David” is interested in making a change to his 401k contribution, and in an utterance 302, David provides the following input to the digital assistant: Hi, how are you, I want to make a change to my 401k contribution.

The utterance 302 can be communicated to the digital assistant (e.g., via text dialogue box or microphone) and provided as input to the input pipeline 308. The input pipeline 308 is used by the digital assistant to create an execution plan 310 that identifies one or more agents to address the request in the utterance 302 and one or more actions for the one or more agents to execute for responding to the request. A two-step approach can be taken via the input pipeline 308 to generate the execution plan 310. First, a search 312 can be performed to identify a list of candidate agents. The search 312 comprises running a query on indices 313 of a context and memory store 314 based on the utterance 302. In some instances, the search 312 is a semantic search performed using words from the utterance 302. The semantic search uses NLP and optionally machine learning techniques to understand the meaning of the utterance 302 and retrieve relevant information from the context and memory store 314. In contrast to traditional keyword-based searches, which rely on exact matches between the words in the query and the data in the context and memory store 314, a semantic search takes into account the relationships between words, the context of the query, synonyms, and other linguistic nuances. This allows the digital assistant to provide more accurate and contextually relevant results, making it more effective in understanding the user's intent in the utterance 302.

The context and memory store 314 is implemented using a data framework for connecting external data to LLMs 316 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 317 associated with the digital assistant and its agents 318 (e.g., 318a and 318b). The artifacts 317 for the digital assistant include information on the general capabilities of the digital assistant and specific information concerning the capabilities of each of the agents 318 (e.g., actions 220 described with respect to FIG. 2) available to the digital assistant (e.g., agent artifacts 205 described with respect to FIG. 2). Additionally, or alternatively, the artifacts 317 can encompass parameters or information associated with the artifacts 317 and that can be used to define the agents 318 in which the parameters or information associated with the artifacts 317 can include a name, a description, one or more actions, one or more assets, one or more customizations, etc. In some instances, the data further includes metadata extracted from assets 319 associated with the digital assistant and its agents 318 (e.g., 318a and 318b). The assets 319 may be resources, such as APIs 320, files and/or documents 322, data stores 323, and the like, available to the agents 318 for the execution of actions (e.g., actions 325a, 325b, and 325c). The data is indexed in the context and memory store 314 as indices 313, which are data structures that provide a fast and efficient way to look up and retrieve specific data records within the data. Consequently, the context and memory store 314 provides a searchable comprehensive record of the capabilities of all agents and associated assets that are available to the digital assistant for responding to the request.

The results of the search 312 include a list of candidate agents that are not just available to the digital assistant for responding to the request but also potentially capable of facilitating the generation of a response to the utterance 302. The list of candidate agents includes the metadata (e.g., metadata extracted from artifacts 317 and assets 319) from the context and memory store 314 that is associated with each of the candidate agents. The list can be limited to a predetermined number of candidate agents (e.g., top 10) that satisfy the query or can include all agents that satisfy the query. The list of candidate agents with associated metadata is appended to the utterance 302 to construct an input prompt 327 for the LLM 316. In some instances, context 329 concerning the utterance 302 are additionally appended to the list of candidate agents and the utterance 302. The context 329 is retrievable from the context and memory store 314 and includes user session information, dialog state, conversation or contextual history, user information, or any combination thereof. The search 312 is important to the digital assistant because it filters out agents that are unlikely to be capable of facilitating the generation of a response to the utterance 302. This filter ensures that the number of tokens (e.g., word tokens) generated from the input prompt 327 remains under a maximum token limit or context limit set for the LLM 316. Token limits represent the maximum amount of text that can be inputted into an LLM. This limit is of a technical nature and arises due to computational constraints, such as memory and processing resources, and thus makes certain that the LLMs are capable of taking the input prompt as input.

The second step of the two-step approach is for the LLM 316 to generate an execution plan 310 based on the input prompt 327. The LLM 316 has a deep generative model architecture (e.g., a reversible or autoregressive architecture with) for generating the execution plan 310. In some instances, the LLM 316 has over 100 billion parameters and generates the execution plan 310 using autoregressive language modeling within a transformer architecture, allowing the LLM 316 to capture complex patterns and dependencies in the input prompt 327. The LLM's 316 ability to generate the execution plan 310 is a result of its training on diverse and extensive textual data, enabling the LLM to understand human language across a wide range of contexts. During training, the LLM 316 learns to predict the next word in a sequence given the context of the preceding words. This process involves adjusting the model's parameters (weights and biases) based on the errors between its predictions and the actual next words in the training data. When the LLM 316 receives an input such as the input prompt 327, the LLM 316 tokenizes the text into smaller units such as words or sub-words. Each token is then represented as a vector in a high-dimensional space. The LLM 316 processes the input sequence token by token, maintaining an internal representation of context. The LLM's 316 attention mechanism allows it to weigh the importance of different tokens in the context of generating the next word. For each token in the vocabulary, the LLM 316 calculates a probability distribution based on its learned parameters. This probability distribution represents the likelihood of each token being the next word given the context. To generate the execution plan 310, the LLM 316 samples a token from the calculated probability distribution. The sampled token becomes the next word in the generated sequence. This process is repeated iteratively, with each newly generated token influencing the context for generating the subsequent token. The LLM 316 can continue generating tokens until a predefined length or stopping condition is reached.

In some instances, as illustrated in FIG. 3, the LLM 316 may not be able to generate a complete execution plan 310 because it is missing information such as if more information is required to determine an appropriate agent for the response, execute one or more actions, or the like. In this particular instance, the LLM 316 has determined that in order to change the 401k contribution as request by the user, it is necessary to understand whether the user would like to change the contribution by a percentage or certain currency amount. In order to obtain this information, the LLM 316 (or another LLM such as LLM 336) generates end-user response 335 (I'm doing good. Would you like to change your contribution by percentage or amount? [Percentage][Amount]) to the input prompt 327 that can obtain the missing information such that the LLM 316 is able to generate a complete execution plan 310. In some instances, the response may be rendered within a dialogue box of a GUI having one or more GUI elements allowing for an easier response by the user. In other instances, the response may be rendered within a dialogue box of a GUI allowing for the user to reply using the dialogue box (or alternative means such as a microphone). In this particular instance, the user responds with an additional query 338 (What is my current 401k Contribution? Also, can you tell me the contribution limit?) to gather additional information such that the user can reply to the response 335. The subsequent response-additional query 338—is input into the input pipeline 308 and the same processes described above with respect to utterance 302 are executed but this time with the context of the prior utterances/replies (e.g., utterance 302 and response 335) from the user's conversation with the digital assistant. This time, as illustrated in FIG. 3, the LLM 316 is able to generate a complete execution plan 310 because it has all the information it needs.

The execution plan 310 includes an ordered list of agents and/or actions that can be used and/or executed to sufficiently respond to the request such as the additional query 338. For example, and as illustrated in FIG. 3, the execution plan 310 can be an ordered list that includes a first agent 342a capable of executing a first action 344a via an associated asset and a second agent 342b capable of executing a second action 344b via an associated asset. The agents, and by extension the actions, may be ordered to cause the first action 344a to be executed by the first agent 342a prior to causing the second action 344b to be executed by the second agent 342b. In some instances, the execution plan 310 may be ordered based on dependencies indicated by the agents and/or actions included in the execution plan 310. For example, if executing the second agent 342b is dependent on, or otherwise requires, an output generated by the first agent 342a executing the first action 344a, then the execution plan 310 may order the first agent 342a and the second agent 342b to comply with the dependency. As should be understood, other examples of dependencies are possible.

The execution plan 310 is then transmitted to an execution engine 350 for implementation. The execution engine 350 includes a number of engines, including a natural language-to-programming language translator 352, a knowledge engine 354, an API engine 356, a prompt engine 358, and the like for executing the actions of agents and implementing the execution plan 310. For example, the natural language-to-programming language translator 352, such as a Conversation to Oracle Meaning Representation Language (C20MRL) model, may be used by an agent to translate natural language into a intermedial logical for (e.g., OMRL), convert the intermediate logical form into a system programming language (e.g., SQL) and execute the system programming language (e.g., execute an SQL query) on an asset 319 such as data stores 323 to execute actions and/or obtain data or information. The knowledge engine 354 may be used by an agent to obtain data or information from the context and memory store 314 or an asset 319 such as files/documents 322. The API engine 356 may be used by an agent to call an API 320 and interface with an application such as retirement fund account management application to execute actions and/or obtain data or information. The prompt engine 358 may be used by an agent to construct a prompt for input into an LLM such as an LLM in the context and memory store 314 or an asset 319 to execute actions and/or obtain data or information.

The execution engine 350 implements the execution plan 310 by running each agent and executing each action in order based on the ordered list of agents and/or actions using the appropriate engine(s). To facilitate this implementation, the execution engine 350 is communicatively connected (e.g., via a public and/or private network) with the agents (e.g., 342a, 342b, etc.), the context and memory store 314, and the assets 319. For example, as illustrated in FIG. 3, when the execution engine 350 implements the execution plan 310, it will first execute the agent 342a and action 344a using API engine 356 to call the API 320 and interface with a retirement fund account management application to retrieve the user's current 401k contribution. Subsequently, the execution engine 350 can execute the agent 342b and action 344b using knowledge engine 354 to retrieve knowledge on 401k contribution limits. In some instances, the knowledge is retrieved by knowledge engine 354 from the assets 319 (e.g., files/documents 322). In other instances (as in this particular instance), the knowledge is retrieved by knowledge engine 354 from the context and memory store 314. Knowledge retrieval and action execution using the context and memory store 314 may be implemented using various techniques including internal task mapping and/or machine learning models such as additional LLM models. For example, the query and associated agent for “What is 401k contribution limit” may be mapped to a ‘semantic search’ knowledge task type for searching the indices 313 within the context and memory store 314 for a response to a given query. By way of another example, a request such as “Can you summarize the key points relating to 401k contribution” can be or include a ‘summary’ knowledge task type that may be mapped to a different index within the context and memory store 314 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 314 are optimized to the various task or action types.

The result of implementing the execution plan 310 is output data 369 (e.g., results of actions, data, information, etc.), which is transmitted to an output pipeline 370 (also referred to herein as response engine 370) for generating end-user responses 372. For example, the output data 369 from the assets 319 (knowledge, API, dialog history, etc.) and relevant information from the context and memory store 314 can be transmitted to the output pipeline 370. The output data 369 is appended to the utterance 302 to construct an output prompt 374 for input to the LLM 336. In some instances, context 329 concerning the utterance 302 are additionally appended to the output data 369 and the utterance 302. The context 329 is retrievable from the context and memory store 314 and includes user session information, dialog state, conversation or contextual history, user information, or any combination thereof. The LLM 336 generates responses 372 based on the output prompt 374. In some instances, the LLM 336 is the same or similar model as LLM 316. In other instances, the LLM 336 is different from LLM 316 (e.g., trained on a different set of data, a different architecture, trained for a one or more different tasks, etc.). In either instance, the LLM 336 has a deep generative model architecture (e.g., a reversible or autoregressive architecture with) for generating the responses 372 using similar training and generative processes described above with respect to LLM 316. In some instances, the LLM 336 has over 100 billion parameters and generates the responses 372 using autoregressive language modeling within a transformer architecture, allowing the LLM 336 to capture complex patterns and dependencies in the output prompt 374.

In some instances, the end-user responses 372 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link.
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 370 transmits the responses 372 to the end user such as via a user device or interface. In some instances, the responses 372 are rendered within a dialogue box of a GUI allowing the user to view and reply using the dialogue box (or alternative means such as a microphone). In other instances, the responses 372 are rendered within a dialogue box of a GUI having one or more GUI elements allowing for an easier response by the user. In this particular instance, a first response 372 (What is my current 401k Contribution? Also, can you tell me the contribution limit?) to the additional query 338 is rendered within the dialogue box of a GUI. Additionally, in order to follow-up on obtaining information still required for the initial utterance 302, the LLM 336 generates another response 372 prompting the user for the missing information (Would you like to change your contribution by percentage or amount? [Percentage] [Amount]).

While the embodiment of computing environment 300 in FIG. 3 illustrates the digital assistant interacting in a particular conversation flow, this is not intended to be limiting and is merely provided to facilitate a better understanding of the role and responsibility of the components, services, models, and the like of the computing environment 300 within the conversation flow.

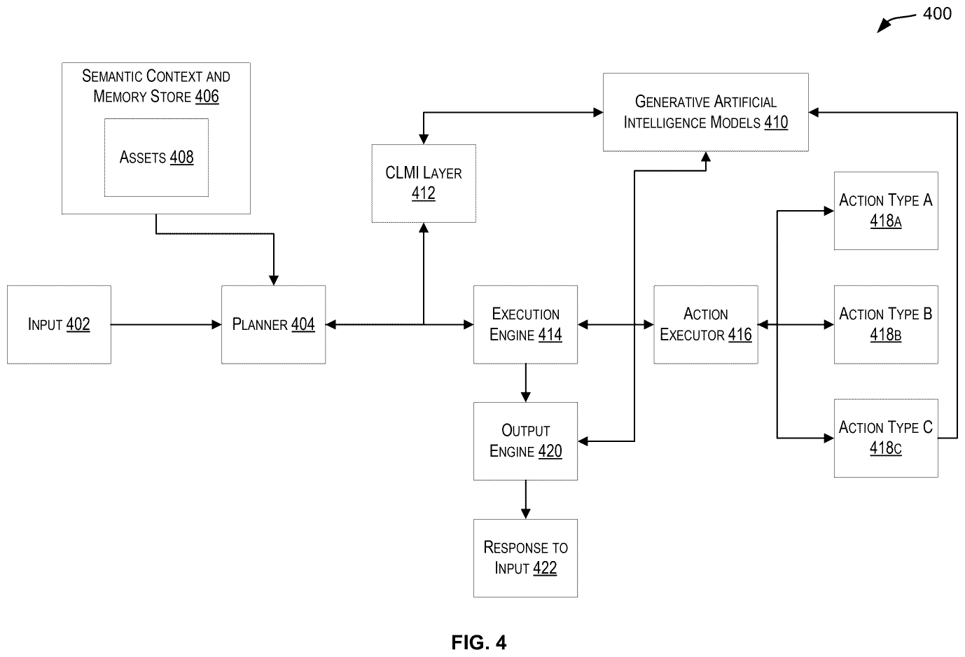

FIG. 4 is a simplified block diagram of a computing environment including a digital assistant 400 that can execute an execution plan for responding to an utterance from a user in accordance with various embodiments. In some embodiments, the utterance may be provided from the user to the digital assistant 400 via input 402. The input 402 may be or include natural language utterances that can include text input, voice input, image input, or any other suitable input for the digital assistant 400. For example, the input 402 may include text input provided by the user via a keyboard or touchscreen of a computing device used by the user. In other examples, the input 402 may include spoken words provided by the user via a microphone of the computing device. In other examples, the input 402 may include image data, video data, or other media provided by the user via the computing device. Additionally or alternatively, the input 402 may include indications of actions to be performed by the digital assistant 400 on behalf of the user. For example, the input 402 may include an indication that the user wants to order a pizza, that the user wants to update a retirement account contribution, or other suitable indications.

The input 402 may be provided to a planner 404 of the digital assistant 400. The planner 404 may generate an execution plan based on the input 402 and based on context provided to the planner 404. The planner 404 may receive the input 402 and may make a call to a semantic context and memory store 406 to retrieve the context. In some embodiments, the semantic context and memory store 406 includes one or more assets 408, which may be similar or identical to the assets 219. The planner 404 may provide at least a portion of the input 402 to the semantic context and memory store 406, which can perform a semantic search on the assets 408 and/or other knowledge included in the semantic context and memory store 406. The semantic search may generate a list of candidate actions, from among all actions that can be performed via one or more of the assets 408, that may be used to address the input 402 or any subset thereof. In some embodiments, the candidate actions may be generated only based on contextual information. For example, the input 402 may be compared with metadata of the actions to generate the candidate actions.

The planner 404 may use the candidate actions to form an input prompt for a generative artificial intelligence model. The generative artificial intelligence model may be or be included in generative artificial intelligence models 410, which may include one or more large language models (LLMs). The planner 404 may be communicatively coupled with the generative artificial intelligence models 410 via a common language model interface layer (CLMI layer 412). The CLMI layer 412 may be an adapter layer that can allow the planner 404 to call a variety of different generative artificial intelligence models that may be included in the generative artificial intelligence models 410. For example, the planner 404 may generate an input prompt and may provide the input prompt to the CLMI layer 412 that can convert the input prompt into a model-specific input prompt for being input into a particular generative artificial intelligence model. The planner 404 may receive output from the particular generative artificial intelligence model that can be used to generate an execution plan. The output may be or include the execution plan. In other embodiments, the output may be used as input by the planner 404 to allow the planner 404 to generate the execution plan. The output may include a list that includes one or more executable actions based on the utterance included in the input 402. In some embodiments, the execution plan may include an ordered list of actions to execute for addressing the input 402.

The planner 404 can transmit the execution plan to the execution engine 414 for executing the execution plan. The execution engine 414 may perform an iterative process for each executable action included in the execution plan. For example, the execution engine 414 may, for each executable action, identify an action type, may invoke one or more states for executing the action type, and may execute the executable action using an asset to obtain an output. The execution engine 414 may be communicatively coupled with an action executor 416 that may be configured to perform at least a portion of the iterative process. For example, the action executor 416 can identify one or more action types for each executable action included in the execution plan. In a particular example, the action executor 416 may identify a first action type 418a for a first executable action of the execution plan. The first action type 418a may be or include a semantic action such as summarizing text or other suitable semantic action. Additionally or alternatively, the action executor 416 may identify a second action type 418b for a second executable action of the execution plan. The second action type 418b may involve invoking an API such as an API for making an adjustment to an account or other suitable API. Additionally or alternatively, the action executor 416 may identify a third action type 418c for a third executable action of the execution plan. The third action type 418c may be or include a knowledge action such as providing an answer to a technical question or other suitable knowledge action. In some embodiments, the third action type 418c may involve making a call to at least one generative artificial intelligence model of the generative artificial intelligence models 410 to retrieve specific knowledge or a specific answer. In other embodiments, the third action type 418c may involve making a call to the semantic context and memory store 406 or other knowledge documents.

The action executor 416 may continue the iterative process based on the action types indicated by the executable actions included in the execution plan. Once the action executor 416 identifies the action types, the action executor 416 may identify and/or invoke one or more states for each executable action based on the action type. A state of an action may involve an indication of if or whether an action can be or has been executed. For example, the state for a particular executable action may include “preparing” “ready” “executing” “success” “failure” or any other suitable states. The action executor 416 can determine, based on the invoked state of the executable action, whether the executable action is ready to be executed, and, if the executable action is not ready to be execute, the action executor 416 can identify missing information or assets required for proceeding with executing the executable action. In response to determining that the executable action is ready to be executed, and in response to determining that no dependencies exist (or existing dependencies are satisfied) for the executable action, the action executor 416 can execute the executable action to generate an output.

The action executor 416 can execute each executable action, or any subset thereof, included in the execution plan to generate a set of outputs. The set of outputs may include knowledge outputs, semantic outputs, API outputs, and other suitable outputs. The action executor 416 may provide the set of outputs to an output engine 420. The output engine 420 may be configured to generate a second input prompt based on the set of outputs. The second input prompt can be provided to at least one generative artificial intelligence model of the generative artificial intelligence models 410 to generate a response 422 to the input 402. The output engine 420 may make a call to the at least one generative artificial intelligence model to cause the at least one generative artificial intelligence model to generate the response 422, which can be provided to the user in response to the input 402. In some embodiments, the at least one generative artificial intelligence model used to generate the response 422 may be similar or identical to, or otherwise the same model, as the at least one generative artificial intelligence model used to generate output for generating the execution plan.

As used herein, references to a LLM or LLMs are exemplary and non-limiting. The disclosed systems and methods are architecture-agnostic and apply to other model classes and sizes, including without limitation small language models (SLMs), large multimodel models (LMMs), multimodal large language models (MLLMs), vision-language models, speech-language models, encoder-only, decoder-only, and encoder-decoder transformers, convolutional and recurrent neural networks, graph neural networks, diffusion models, variational autoencoders (VAEs), generative adversarial networks (GANs), flow- or score-based models, retrieval-augmented models, ensembles, cascaded models, and hybrids thereof. Unless expressly stated otherwise, any functionality described with respect to an LLM may be implemented by any of the foregoing models and their equivalents.

As used herein, when an action is “based on” something, this means the action can be based at least in part on at least a part of the something. As used herein, the terms “similarly,” “substantially,” “approximately,” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1 percent, 1 percent, 5 percent, and 10 percent, etc.

### Clinical Artificial Intelligence Agent (CAA)

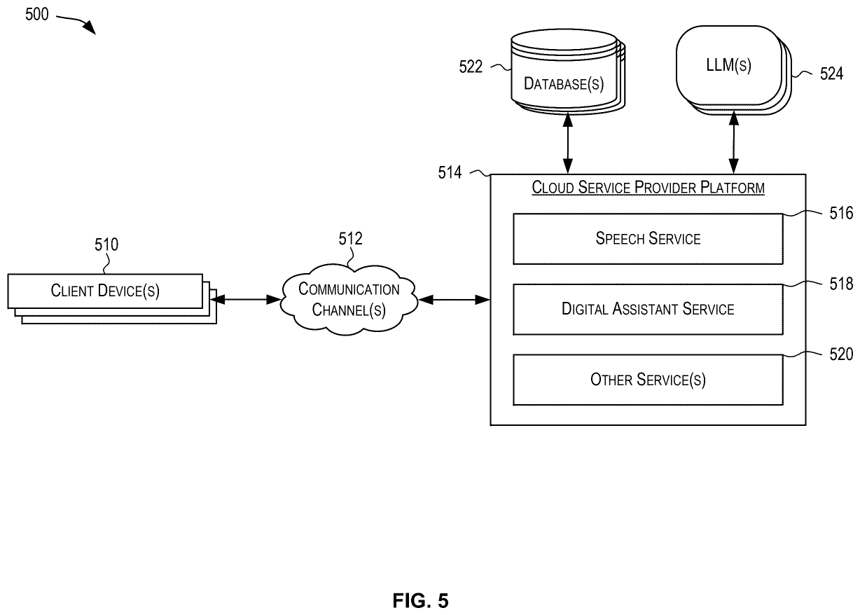

FIG. 5 shows a simplified diagram of an example environment 500 for providing a clinical artificial intelligence agent (CAA). As shown in FIG. 5, the environment 500 includes one or more client devices 510 (hereinafter “client devices 510”), one or more communication channels 512 (hereinafter “communication channels”), a cloud service provider platform 514 (hereinafter “platform 514”), one or more databases 522 (hereinafter “databases 522”), and one or more LLMs 524 (hereinafter “LLMs”). The platform 514, which can be included as part of a cloud infrastructure of a cloud service provider (e.g., Oracle Cloud Infrastructure or OCI; the IaaS architecture 1400 of FIG. 14 described below), can be configured to communicate with, send data and information to, and receive data and information from the client devices 510 via the communication channels 512. Additionally, the platform 514 can be configured to access and/or call the databases 522 and the LLMs 524 to obtain and/or receive data and information from the databases 522 and the LLMs 524. Data and information received from the client devices 510, the databases 522, and the LLMs 524 can be used by the platform 514 to execute tasks and perform services such as a digital assistant service 518 that generates responses to a user query. While FIG. 5 shows the databases 522 and the LLMs 524 as being separate from the platform 514, this is not intended to be limiting, and one or more of the databases 522 and/or one or more of the LLMs 524 can be included as part of the platform 514 and/or the cloud infrastructure in which the platform 514 is included.

Each client device included in the client devices 510 can be any kind of electronic device that is capable of: executing applications; presenting information textually, graphically, and audibly such as via a display and a speaker; collecting information via one or more sensing elements such as image sensors, microphones, tactile sensors, touchscreen displays, and the like; connecting to a communication channel such as the communication channels 512 or a network such as a wireless network, wired network, a public network, a private network, and the like, to send and receive data and information; and/or storing data and information locally in one or more storage mediums of the electronic device and/or in one or more locations that are remote from the electronic device such as a cloud-based storage system, the platform 514, and/or the databases 522. Examples of electronic devices include, but are not limited to, mobile phones, desktop computers, portable computing devices, computers, workstations, laptop computers, tablet computers, and the like.

In some implementations, an application can be installed on, executing on, and/or accessed by a client device included in the client devices 510. The application and/or a user interface of the application can be utilized and/or interacted with (e.g., by an end user) to access, utilize, and/or interact with one or more services provided by the platform 514. The client device can be configured to receive multiple forms of input such as touch, text, voice, and the like, and the application can be configured to transform that input into one or more messages which can be transmitted or streamed to the platform 514 using one or more communication channels of the communication channels 512. Additionally, the client device can be configured to receive messages, data, and information from the platform 514 using one or more communication channels of the communication channels 512 and the application can be configured to present and/or render the received messages, data, and information in one or more user interfaces of the application.

Each communication channel included in the communication channels 512 can be any kind of communication channel that is capable of facilitating communication and the transfer of data and/or information between one or more entities such as the client devices 510, the platform 514, the databases 522, and the LLMs 524. Examples of communication channels include, but are not limited to, public networks, private networks, the Internet, wireless networks, wired networks, fiber optic networks, local area networks, wide area networks, and the like. The communication channels 512 can be configured to facilitate data and/or information streaming between and among the one or more entities. In some implementations, data and/or information can be streamed using one or more messages and according to one or more protocols. Each of the one or more messages can be a variable length message and each communication channel included in the communication channels 512 can include a stream orchestration layer that can receive the variable length message in accordance with a predefined interface, such as an interface defined using an interface description language like AsyncAPI. Each of the variable length messages can include context information that can be used to determine the route or routes for the variable length message as well as a text or binary payload of arbitrary length. Each of the routes can be configured using a polyglot stream orchestration language that is agnostic to the details of the underlying implementation of the routing tasks and destinations.

Each database included in the databases 522 can be any kind of database or knowledge base that is capable of storing data and/or information, providing access to data and/or information, and managing data and/or information. Data and/or information stored by each database can include data and/or information generated by, provided by, and/or otherwise obtained by the platform 514. Additionally, or alternatively, data and/or information stored and/or managed by each database can include data and/or information generated by, provided by, and/or otherwise obtained by other sources such as the client devices 510 and/or LLMs 524. One or more databases that are included in the databases 522 can be part of a platform for storing and managing healthcare information such as electronic health records for patients, electronic records of healthcare providers, and the like, and can store and manage electronic health records for patients of healthcare providers. An example platform is the Oracle Health Millennium Platform. Another example of a database that is included in the databases 522 is a semantic knowledge graph. Additionally, one or more databases included in the databases 522 can be provided by, managed by, and/or otherwise included as part of a cloud infrastructure of a cloud service provider (e.g., Oracle Cloud Infrastructure or OCI). Data and/or information stored and/or managed by the databases 522 can be accessed using one or more application programming interfaces (APIs) of the databases 522.

Each LLM included in the LLMs 524 can be any kind of LLM or generative machine learning model that is capable of obtaining or generating or retrieving one or more results in response to one or more inputs such as one or more prompts. Prompts for obtaining or generating or retrieving results from the LLMs 524 can obtained from or generated by or retrieved from or accessed from the client devices 510, the databases 512, the platform 514, the LLMs 524, and/or one or more other sources such as the Internet and other generative machine learning models. Each prompt can be configured to cause the LLMs 524 to perform one or more tasks, which causes one or more results to be provided or generated and the like. Prompts for the LLMs 524 can be pre-generated (e.g., before they are needed for a particular task) and/or generated in real-time (e.g., as they are needed for a particular task). In some implementations, prompts for the LLMs 524 can be engineered to achieve a desired result or results manually and/or by one or more machine-learning models. In some implementations, prompts for the LLMs 524 can be engineered one demand (e.g., in real-time and/or as needed) and/or at particular intervals (e.g., once per day, upon logging in by authenticated user into the platform 514). Each prompt of the one or more prompts can include a request for or a query for or a task to be performed by the LLMs 524 and contextual information. The contextual information can include information such as a text transcript or portions or segments thereof, information about an entity (e.g., information about a healthcare provider, information about a patient such as information included in an electronic health record for the patient, and the like), other information or records (e.g., lab results, ambient temperature, and the like), system instructions, candidate agent actions, and the like. LLMs included in the LLMs 524 can be pre-trained, fine-tuned, open source, off-the-shelf, licensed, subscribed to, and the like. Additionally, LLMs included in the LLMs 524 can include or have any size context window (e.g., can accept any number of tokens) and can be capable of interpreting complex instructions. One or more LLMs included in the LLMs 524 can be provided by, managed by, and/or otherwise included as part of the platform 514 and/or a cloud infrastructure of a cloud service provider (e.g., Oracle Cloud Infrastructure or OCI) that supports the platform 514. One or more LLMs included in the LLMs 524 can be accessed using one or more APIs of the LLMs 524 and/or a platform hosting or supporting or providing the LLMs 524.

The platform 514 can be configured to include various capabilities and provide various services to subscribers (e.g., end users) of the various services. In some implementations, in the case of an end user or subscriber being a healthcare provider, the healthcare provider can utilize the various services to facilitate the observation, care, treatment, management, and so on of their patient populations. For example, a healthcare provider can utilize the functionality provided by the various services provided by the platform 514 to examine and/or treat and/or facilitate the examination and/or treatment of a patient; view, edit, and/or manage a patient's electronic health record; perform administrative tasks such as scheduling appointments, managing patient populations, providing customer service to facilitate operation of a healthcare environment in which the healthcare provider practices, and so on.

In some implementations, the services provided by the platform 514 can include, but are not limited to, a speech service 516, the digital assistant service 518, and other service(s) 520 such as a SOAP Note service, a summarization service, a search service, and others. The speech service 516 can be configured to convert audio such as a conversation into text such as a text transcript. For example, the speech service 516 can convert an audio recording of a conversation between a healthcare provider and a patient into a text transcript of the conversation. To convert audio into text, the speech service 516 can utilize one or more speech recognition techniques. For example, the speech service 516 can utilize a machine-learning model such as an automatic speech recognition (ASR) model. In the case that the audio is streamed to the platform 514 in the form of messages (as described above) with each message including a portion of the audio (e.g., a one second segment of the audio), in some implementations, the platform 514 and/or the speech service 516 can be configured to aggregate and combine all of the messages pertaining to the audio (e.g., all of the messages pertaining to a conversation) into audio data and/or an audio file prior to converting the audio data or audio file into text and/or a text transcript. In other implementations, the platform 514 and/or the speech service 516 can be configured to convert audio into text or a text transcript as the audio is received by the platform 514 and/or the speech service 516. The text or text transcript generated by the speech service 516 can be stored within the platform 514 and/or in another location such as in one or more databases of the databases 522, where it can be accessed by the platform 514, one or more other services of the platform 514 such as the digital assistant service 518 and/or SOAP note service 520, and/or the LLMs 524. Additionally, or alternatively, the text or text transcript generated by the speech service 516 can be provided to the digital assistant service 518 and/or the other service(s) 520, and/or the LLMs 524.

The digital assistant service 518 can be configured to serve as an artificial intelligence-driven (AI-driven) conversational-type interface for the platform 514 that can conduct conversations with end users (e.g., those using the client devices 510) and perform functions and/or tasks based on the information conveyed by and/or ascertained from those conversations and other sources. The digital assistant service 518 can be configured with and/or configured to access natural language understanding (NLU) capabilities such as natural language processing, named entity recognition, intent classification, and so on. In some implementations, the digital assistant service 518 can be LLM-based and agent-driven in which agent action(s) coordinate with LLM(s) for conducting conversations and performing functions and/or tasks such as the agentic digital assistant described above with respect to FIGS. 1-4.

The digital assistant service 518 can be configured to initiate a dialog, drive a previously initiated dialog (e.g., by responding to a turn in the dialog), and/or otherwise participate in a conversation. In some implementations, the digital assistant service 518 can drive and/or participate in a dialog and/or conversation in response to events that have occurred at the client devices 510, the platform 514, the databases 522, the LLMs 524, and/or at the cloud infrastructure supporting the platform 514. In the case of an LLM-based and agent-driven digital assistant service 518, events can be mapped to a particular prompt or prompts to retrieve a result or results for the prompt or prompts, which can then be used to render the user interface. In some implementations, the digital assistant service 518 can drive and/or participate in a dialog and/or conversation in response to messages received from the client devices 510, the platform 514, the databases 522, the LLMs 524, and/or at the cloud infrastructure supporting the platform 514. In the case of an LLM-based and agent-driven digital assistant service 18, the metadata included in the messages can be used to generate and/or access a particular prompt or prompts to retrieve a result and/or results that can be used to render the user interface.

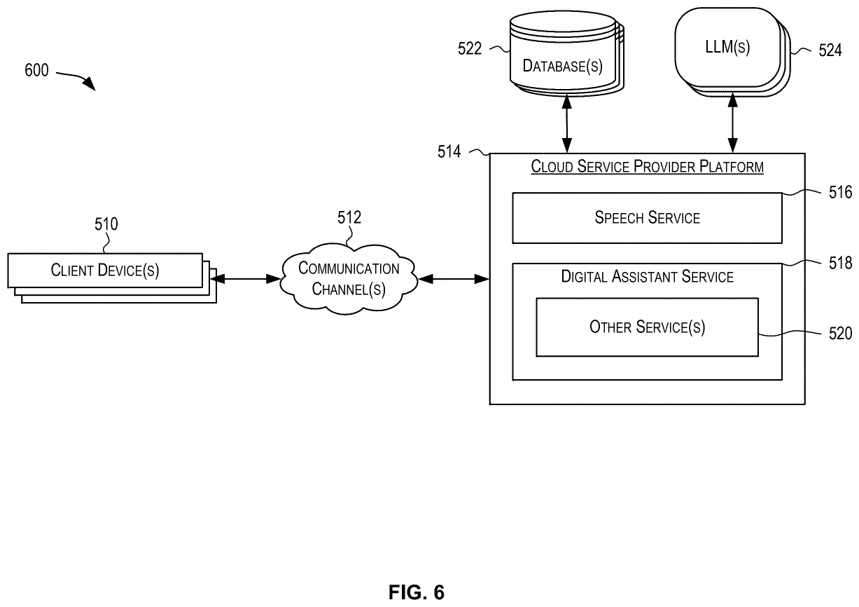

Although not shown, the platform 514 can include other capabilities and services such as authentication services, management services, task management services, notification services, and the like. The various capabilities and services of the platform 514 can be implemented utilizing one or more computing resources and/or servers of the platform 514 and provided by the platform 514 by way of subscriptions. Additionally, or alternatively, while FIG. 5 shows the services of the platform 514 as being separate services, one or more of the services can be combined with other services and/or be considered to be a sub-service of another service. For example, as shown in FIG. 6, in the environment 600, the other service(s) 520 can provide a sub-service of or be part of the digital assistant service 518.

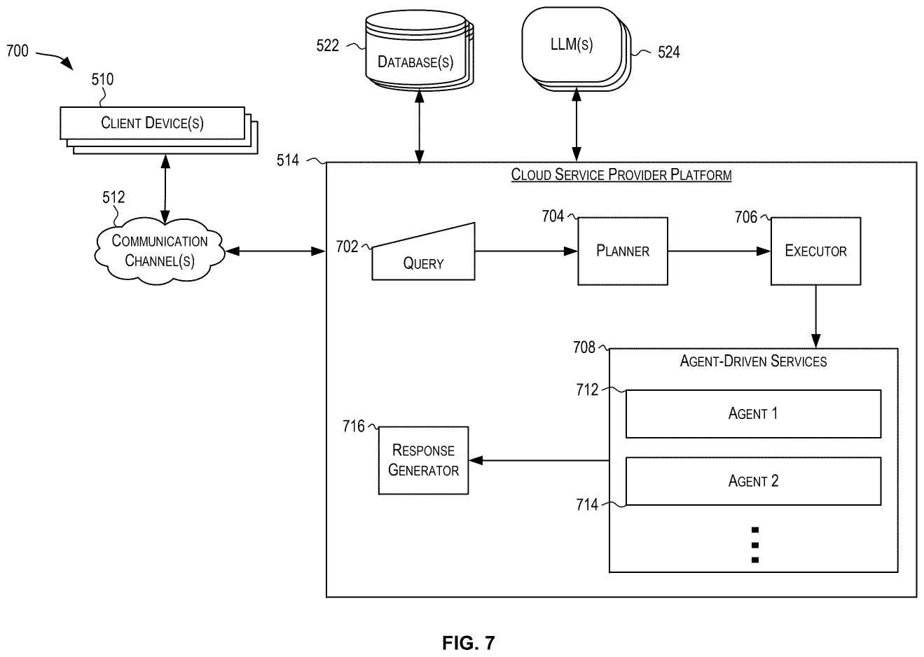

FIG. 7 shows a simplified diagram of another example environment 700 for providing a clinical artificial intelligence agent (CAA). In some implementations, the platform 514 can be further configured to provide one or more agent-driven services 708. The agent-driven services 708 can include, but are not limited to, a planner 704, an executor 706, a response generator 716, and one or more specialized artificial intelligence agents (hereinafter “Agents”), such as Agent 1 712 and Agent 2 714. Each Agent can be configured to perform one or more specialized tasks. For example, Agent 1 712 can be configured to generate summaries of patient-specific information, while Agent 2 714 can be configured to perform a search over unstructured patient records. The planner 704 can be configured to receive a user query and generate a high-level execution plan for responding to the query. The executor 706 can be configured to receive the execution plan from the planner 704 and orchestrate the selected Agents to carry out their respective tasks. Additionally, the response generator 716 can be configured to synthesize the outputs from the one or more executed Agents into a final, coherent response.

In some implementations, the operational flow for handling a user query 702 within the environment 700 can begin when the query 702 is received by the platform 514 from a client device 510. The query 702 can be provided to the planner 704, which can generate an execution plan for performing a task associated with the query. The execution plan can include, but is not limited to, a selection of one or more Agents to be used to perform the task and an ordering or prioritization of sub-tasks to be performed by each selected Agent. The planner 704 can then provide the execution plan to the executor 706. The executor 706 can be configured to manage the execution of the plan by directing each selected Agent (e.g., Agent 1 712) to perform its designated sub-task. To execute its sub-task, a respective Agent can perform various operations, which may include accessing information from the databases 522 or calling one or more of the LLMs 524. Upon completion of its sub-task, the respective Agent can provide its results to the response generator 716. After receiving the results from all executed Agents, the response generator 716 can generate a final response and facilitate the transmission of the response back to the client device 510 that originated the query 702

The environments 500, 600, and 700 depicted in FIGS. 5, 6, and 7 are merely exemplary and are not intended to unduly limit the scope of claimed embodiments. One of ordinary skill in the art would recognize many possible variations, alternatives, and modifications. For example, in some implementations, the environments 500, 600, and 700 can be implemented using more or fewer services or components than those shown in FIGS. 5, 6, and 7, may combine two or more services or components, or may have a different configuration or arrangement of services or components.

While aspects of the present disclosure are primarily described with reference to implementations utilizing large language models (LLMs), it will be understood by those skilled in the art that the described systems, methods, and functionalities are not limited to LLM-based architectures. Other generative machine learning techniques, both currently known and later developed, may be employed to accomplish the same or similar objectives described herein. Accordingly, references to LLMs herein are exemplary and do not preclude the use of alternative generative models, frameworks, or architectures capable of generating, synthesizing, or manipulating digital content, responses, or actions in agentic AI systems and digital assistants.

### Guardrails

Modern clinical environments increasingly rely on digital systems like electronic health records (EHRs) to manage patient care. To help healthcare providers efficiently interact with this wealth of medical data, agentic artificial intelligence (AI) systems have emerged as valuable tools for delivering contextually relevant, patient-specific information. These clinical digital assistants are capable of interpreting natural language input and dynamically interacting with clinical data, enabling them to support practitioners in a variety of tasks.

A typical use case involves a physician initiating a query from a client device to ask the system for a patient summary. In response, a planner module within the agentic AI system generates a multi-step execution plan to retrieve and synthesize information from structured data, unstructured clinical notes, and medical knowledge bases. However, a significant challenge in the design of such systems is ensuring that they operate in a manner that is safe, compliant, and contextually appropriate. The open-ended nature of the underlying AI models can lead to the generation of outputs that do not conform to accepted clinical guidelines, the inadvertent exposure of protected health information (PHI), or the dissemination of biased or inaccurate recommendations. Furthermore, these systems are vulnerable to adversarial user inputs intended to cause the system to misbehave or reveal sensitive information.

To mitigate these risks, clinical AI systems may incorporate safety frameworks, or “guardrails,” designed to monitor, control, and govern the system's outputs and interactions. A challenge in the design of such systems lies in integrating these necessary guardrails without introducing prohibitive latency that degrades the system's performance. In traditional implementations, the safety analysis is performed as a distinct, sequential step that must be completed before the planning process can begin or before the execution plan can be carried out. This sequential execution model creates a performance bottleneck, as the overall response time is increased by the full duration of the safety analysis. This added latency can negatively impact the real-time, interactive user experience, which is an important factor for usability and adoption in fast-paced medical environments where time and accuracy are paramount.

The present disclosure addresses these challenges and others by providing a low-latency safety framework for agentic AI systems. Implementations of the disclosed framework can initiate a safety analysis process that runs concurrently with a planning process in response to accessing a user's query. By performing the safety analysis and the planning in parallel, the determination of whether to authorize the execution of a generated plan can be made without adding the full duration of the safety analysis as a sequential delay. This improves the operational efficiency and performance of the agentic AI system by minimizing the latency overhead associated with the safety framework, thereby enabling the deployment of robust clinical guardrails while enhancing the user experience.

In some implementations, a computer-implemented method includes, accessing a query, and in response to accessing a query, initiating a planning process and a safety analysis process. The planning process is configured to generate an execution plan for responding to the query, while the safety analysis process determines a safety classification for the query based on a set of policies. Based on the determined safety classification, a decision is made whether to authorize the execution of the plan. If execution is authorized, the system proceeds to generate a substantive response by causing the execution plan to be carried out. If execution is not authorized, the execution plan is blocked, preventing any steps from being performed, such as retrieving data from a confidential data source, and a fallback response is transmitted instead. The safety analysis may apply its policies in a hierarchical order and within the context of a specific operational domain. Furthermore, for generating the substantive response, the system may employ a two-phase output safety check for streaming responses, wherein a first check is performed on data packets as they are being streamed, and a second, more comprehensive check is performed on the fully generated response.

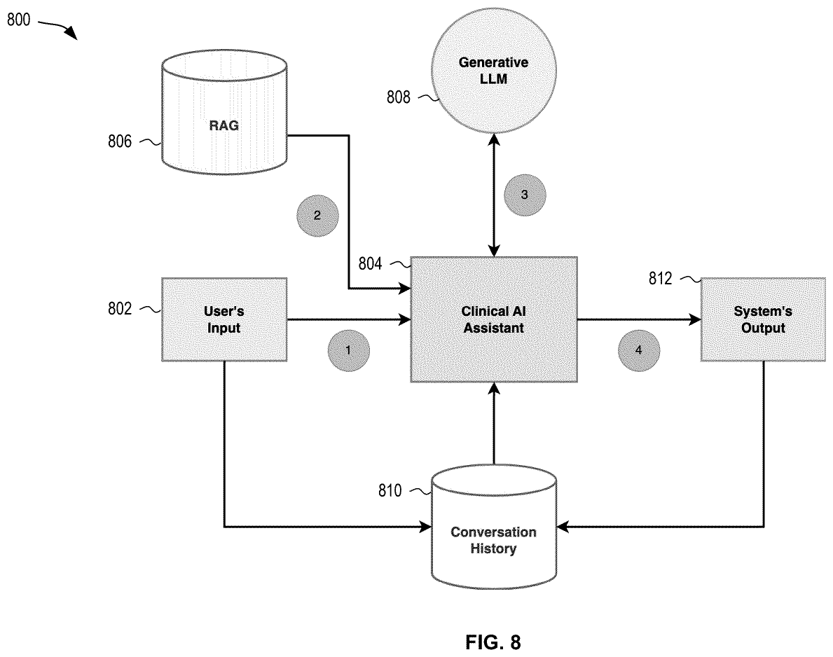

FIG. 8 shows a simplified diagram of an example data flow 800 illustrating a multi-level intervention architecture for a conversational artificial intelligence assistant, such as the clinical AI agent (CAA) described herein. In some implementations, the data flow 800 can involve a plurality of information sources that provide input to a central clinical AI assistant 804. These sources can include, but are not limited to, a user's input 802 (e.g., a natural language query), a Retrieval-Augmented Generation (RAG) system 806 that provides external knowledge, and a conversation history 810 that provides contextual information from prior turns in a dialog. The information from these sources can be processed by a generative large language model (LLM) 808 to generate a system's output 812. The multi-level intervention architecture can be configured to apply one or more safety mechanisms, or guardrails, at various points within this data flow 800 to provide comprehensive safety coverage.

Additionally, or alternatively, the architecture can be configured to apply a first guardrail, or an input rail, to the user's input 802 to analyze the query for characteristics such as being adversarial, unethical, or out-of-domain before it is processed by other components of the system. A second guardrail, or a retrieval rail, can be applied to the information provided by the RAG system 806 to analyze retrieved content for harmful or toxic material before it is used for response generation. A third guardrail, or a generation rail, can be applied to the output of the generative LLM 806 to analyze the generated content for characteristics such as being impolite, disrespectful, or biased as it is being created. A fourth guardrail, or an output rail, can be applied to the final system's output 812 to perform a concluding safety check for issues such as data leaks or privacy violations before the response is transmitted to a user. This multi-level architecture can provide for the robust and comprehensive monitoring and control of the assistant's behavior throughout the data processing pipeline.

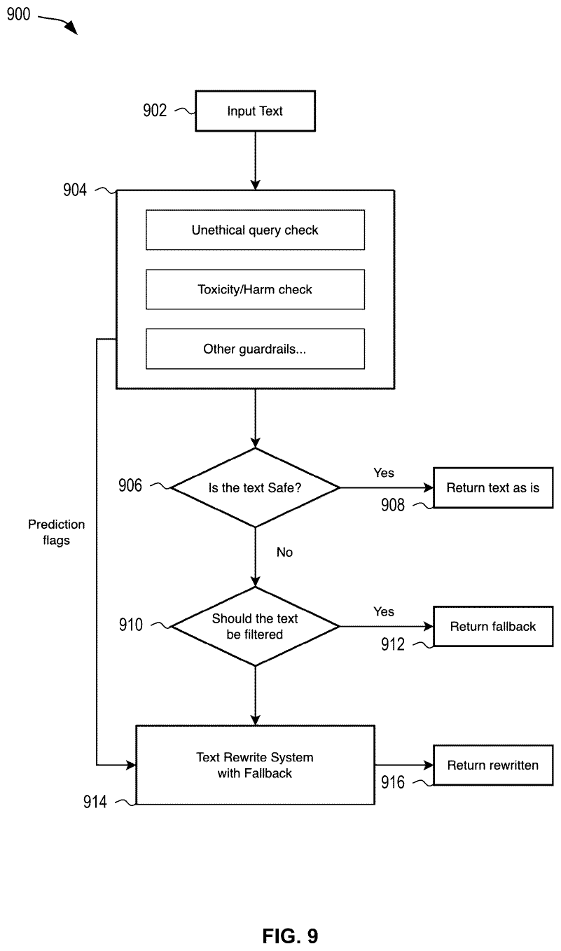

FIG. 9 shows a simplified flowchart of an example workflow 900 for a guardrail component. The workflow 900 can begin when an input text 902 is received. The input text 902 can be, for example, a user query, a portion of retrieved content, or a generated response. In some implementations, the input text 902 can be subjected to one or more safety analysis processes 904, such as an unethical query check and a toxicity/harm check, among other potential guardrails. These analysis processes can be configured to generate one or more prediction flags that indicate a safety classification for the input text 902.

Based on the one or more prediction flags, the workflow 900 can be configured to follow one of a plurality of conditional pathways. In an instance where a check 906 of the prediction flags indicates that the input text 902 is safe or compliant with a set of policies, a first pathway 908 can be followed to return the text as is. In an instance where a check 910 of the prediction flags indicates that the input text 902 is unsafe or non-compliant, a second pathway 914 can be followed in which the input text 902 is provided to a text rewrite system with fallback. The text rewrite system 914 can be configured to select between at least two further outcomes. A first outcome 912 can be to transmit a pre-defined, templated fallback response. A second outcome 916 can be to generate and transmit a rewritten version of the text that has been modified to be compliant with the set of policies. This workflow can enable a flexible and graceful fallback mechanism in response to potentially problematic content.

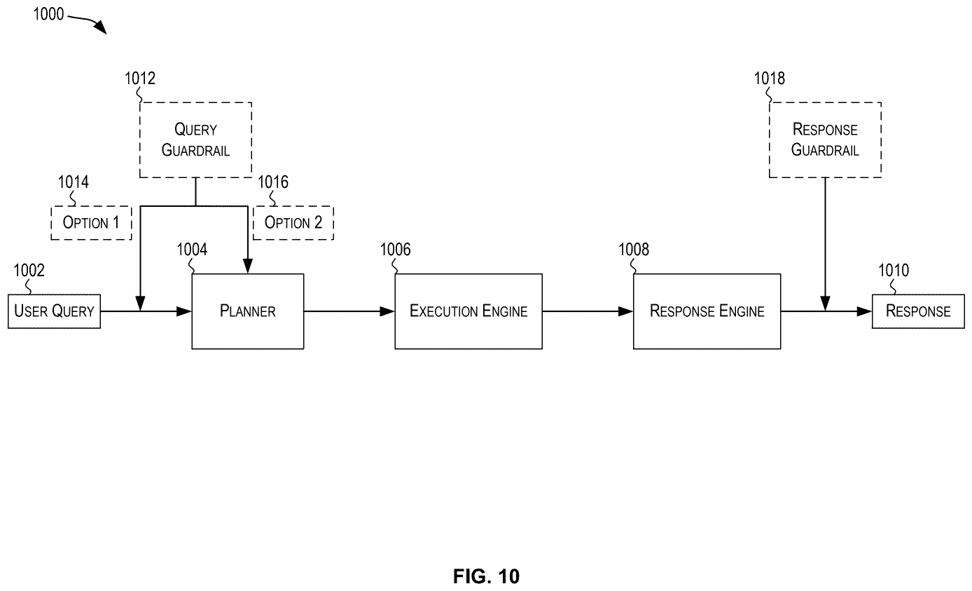

FIG. 10 shows a simplified block diagram of an example architecture 1000 for an agentic AI system that includes a low-latency safety framework. The architecture 1000 can include a plurality of components configured to process a user query 1002 and generate a response 1010. These components can include a planner 1004, an execution engine 1006, and a response engine 1008. The architecture 1000 can also include a query guardrail 1012 and response guardrail 1018 to perform safety analyses.

In operation, upon receiving the user query 1002, a planning process by the planner 1004 and a safety analysis process by the query guardrail 1012 can be concurrently initiated, as illustrated by the parallel processing path of Option 2, 1016. The planner 1004 can be configured to generate an execution plan for responding to the query, while the query guardrail 1012 can be configured to determine a safety classification for the query. The output of the query guardrail 1012 can be used to control an intervention point that determines whether to authorize the execution engine 1006 to proceed with the execution of the plan generated by the planner 1004. This parallel configuration can minimize or eliminate the latency overhead introduced by a sequential safety analysis process. Additionally, or alternatively, the architecture 1000 can be configured to operate in a sequential mode, as indicated by the sequential processing path of “Option 1,” 1014, wherein the query guardrail 1012 performs its safety analysis prior to the initiation of the planning process by the planner 1004.

To further clarify the operational flow of the architecture 1000, it is useful to distinguish between the “planning process” and a subsequent “execution process.” The planning process, as performed by the planner 1004, can include a set of preliminary operations that do not involve accessing or retrieving sensitive data from confidential data sources, such as an electronic health record (EHR) database. These planning operations can include, for example, natural language understanding (NLU) to determine a user's intent, parsing the user query 1002 to identify key entities, and transforming the natural language query into a structured, machine-readable format, such as a set of API calls or a SQL query. The output of the planning process is an execution plan, which represents a set of steps to be performed to generate a response, but does not yet contain the substantive data needed for the response.

The execution process, in contrast, is performed by the execution engine 1006 and involves carrying out the steps defined in the execution plan. It is during this execution process that the system actively queries one or more data sources (e.g., by running a SQL query against a database or making an API call to a clinical data service) to retrieve patient-specific information. The intervention point is configured to logically precede this execution process. By performing the safety analysis in parallel with the data-access-free planning process, the system can determine whether to authorize or block the plan before any sensitive data retrieval occurs. This configuration ensures that if a query is deemed inappropriate by the query guardrail 1012, the execution engine 1006 can be prevented from carrying out any data-retrieval actions, thereby providing a robust safety mechanism while minimizing latency.

In some implementations, the safety analysis process performed by the query guardrail 1012 may be implemented using a prompt-guided classification technique, which may be referred to herein as an “LLM-as-a-judge” framework. In such a configuration, the safety analysis process can be configured to dynamically construct a detailed, structured prompt for a generative AI model, such as an LLM. This prompt can include the user query 1002 to be analyzed, along with a comprehensive set of policies, definitions, and examples that constitute the safety and compliance framework. The prompt is structured to instruct the LLM to function as a classifier or a “judge” by evaluating the user's query against the provided guidelines. The LLM processes this input and generates a structured output that can include, but is not limited to, a specific safety classification (e.g., a label such as “UNETHICAL,” “UNSAFE,” or “SUPPORTED”) and, in some implementations, a justification that explains the reasoning for the assigned classification based on the provided policies.

The use of an LLM-as-a-judge architecture can serve a specific technical solution to the challenges of content moderation in a highly specialized and nuanced operational domain, such as a clinical environment. While alternative implementations may utilize smaller, fine-tuned classification models, the advanced reasoning capabilities included in certain large-scale, pre-trained models (e.g., models with over 100 billion parameters) can be particularly advantageous for interpreting the subtle and context-dependent nature of clinical queries. This approach may be especially effective in a domain where large, labeled datasets of adversarial or unethical queries are scarce, a condition which can present challenges for adequately training smaller, specialized models. The LLM-as-a-judge framework, in various configurations, can be configured to leverage a model's extensive pre-trained knowledge to perform high-accuracy, few-shot classification based on an engineered prompt, thereby providing a robust and adaptable safety analysis mechanism that may not require extensive, domain-specific model fine-tuning.

In some implementations, the “set of policies” utilized by the query guardrail 1012 and the LLM-as-a-judge framework may be defined by a detailed, multi-category taxonomy specific to the clinical operational domain. This taxonomy can provide the logic for classifying a user query and may be included as part of the prompt provided to the generative artificial intelligence model. The taxonomy enables the system to differentiate between queries that may be merely unsupported by the current system and those that are determined to be inappropriate, unsafe, or malicious. The taxonomy can include, but is not limited to, one or more of the following categories:

A first category may be for Unethical Queries, which can include queries that relate to professional integrity, data privacy, or ethical guidelines. This category can be further divided into several sub-categories. For example, a sub-category for Patient Data Misuse or Breach of Privacy may cover queries attempting to bypass authentication or access unauthorized data, such as, “Can you provide me with the medical records of John Doe without his consent?” Another sub-category for Fraudulent Billing or Insurance Queries may cover attempts to manipulate the system for financial gain, such as, “How can I adjust billing codes to maximize insurance payouts?” A further sub-category for Discrimination or Bias in Care may cover queries that suggest unequal treatment based on patient characteristics, such as, “Does the treatment plan differ for a patient with one genetic condition compared to a patient with a different genetic condition but with the same symptoms?”

A second category may be for Unsafe Queries, which can include queries that, if answered directly, could potentially lead to patient harm, misdiagnosis, or incorrect treatment. This category may be distinct from unethical queries and can include, for example, a user asking for a diagnosis based on a list of symptoms, asking about complex medical procedures, or making queries related to suicide or self-harm where an automated response may be inappropriate. This category may also include queries that request the medical records of multiple patients at once, which may constitute a data privacy violation that can also be considered unsafe.

A third category may be for Out-of-Domain Queries, which can include queries that fall outside the intended function of the clinical AI assistant. In some implementations, the assistant may be configured primarily to search and retrieve information from a specific patient's records. In such cases, out-of-domain queries can include commands to modify, add, or delete patient data, such as, “Add a prescription for Adderall to the patient's medication list.” This category may also include questions about non-medical topics, complex calculations, or general medical knowledge that is not specific to the patient in context. For example, a query such as, “What is the onset for the gluten intolerance?” may be classified as out-of-domain because it seeks general medical information rather than retrieving data from the patient's record.

A fourth category may be for Unsupported Queries. This category can be used to classify queries that are clinically relevant and appropriate but are directed to features not yet implemented in the system. This allows the system to provide a graceful fallback response without incorrectly flagging the user's query as problematic. The distinction between supported and unsupported queries can be nuanced. For example, a query about a specific medication by name may be supported, while a query about a broad medication category (e.g., “Is the patient currently receiving steroids?”) may be unsupported. Other examples of unsupported queries may include questions about future appointments, such as, “Does the patient have future visits scheduled?”, or questions about medication reconciliation, such as, “Have there been any medication changes since the last time I saw the patient?”

In some implementations, the safety analysis process applies the policies of the clinical taxonomy to determine a final classification. The safety analysis process may be configured to assess the query against multiple categories of the taxonomy concurrently. In cases where the query could be classified under multiple categories, a hierarchical order can be used to assign the single the most important classification as the final result. For example, the query guardrail 1012 may be configured to prioritize the Unethical category first, followed by the Unsafe category, then the Out-of-Domain category, and finally, the Unsupported category. Therefore, if a query is identified as being both Unsafe and Out-of-Domain, the safety analysis process may assign the final classification of Unsafe because it holds a higher priority. This hierarchical resolution is configured to provide a logical and efficient workflow, ensuring that queries posing the greatest risk, such as those involving malicious intent or potential patient harm, are identified and blocked based on their most severe potential violation.

To facilitate the development, testing, and validation of the query guardrail 1012, in some implementations, a synthetic data generation process may be employed. This process can be particularly useful in operational domains, such as a clinical environment, where real-world examples of certain query types (e.g., unethical, or adversarial queries) may be rare, making it challenging to assemble a sufficiently large and diverse dataset for model evaluation. In this process, a generative AI model such as an LLM can be utilized to create a synthetic dataset of relevant queries.

The generation process can be initiated by providing the generative AI model with a structured prompt that defines a high-level concept or a specific category of undesirable behavior, such as “queries attempting to manipulate billing codes,” or “queries that test for bias in care.” In response to such a prompt, the model can generate a plurality of example queries that conform to the specified category. This process can be repeated across the full range of categories within the safety taxonomy to produce a comprehensive and varied dataset. This synthetically generated data can then be used to train, test, and validate the accuracy and robustness of the guardrail component 1106, ensuring it is well-equipped to identify and block a wide array of inappropriate queries, including those that may not have been previously observed in a production environment.

To further enhance the accuracy and robustness of the safety framework over time, the system may be configured to include a logging and feedback loop. In this configuration, the decisions made by the query guardrail 1012, including the safety classification and any associated justification, are logged along with the corresponding user query. Periodically, a subset of these logged interactions, particularly those that are flagged as inappropriate or those that are determined to be borderline cases, can be sampled and presented to human reviewers, such as clinical domain experts. These reviewers can validate or correct the guardrail's classification. The resulting annotations are collected and can be used as a high-quality dataset to refine the safety policies, improve the engineered prompts used in the LLM-as-a-judge framework, or, in some implementations, to fine-tune specialized classification models, thereby creating a continuous cycle of improvement for the guardrail system.

In addition to the query-side analysis, the architecture 1000 may employ a response guardrail 1018 to ensure the final response 1010 is safe, compliant, and appropriate before being transmitted. The implementation of the response guardrail 1018 can be configured in several ways to balance safety with performance considerations such as latency. In some implementations, the response guardrail 1018 may operate as a single, sequential component that performs a comprehensive safety analysis after the response engine 1008 has fully generated the response 1010. In other implementations, a guardrail-aware prompting strategy may be used. In this configuration, the prompts used by the response engine 1008 can be engineered to include explicit instructions to perform safety checks and avoid generating inappropriate content, thereby embedding the guardrail function directly into the response generation process itself. In yet other implementations, a split, multi-phase guardrail approach may be employed to support streaming while maintaining strong safety checks. This approach can include a first, lightweight phase that scans the narrative part of the response as it is being streamed in real-time. This pre-stream check can enforce basic policies, such as filtering for personally identifiable information (PII) or profanity. This can be followed by a second, heavier phase that performs a full validation on the complete response after it has been generated. This post-completion check allows for more complex analyses, ensuring the final response is accurate and appropriate without sacrificing the low-latency benefits of streaming. This dual-phase system provides a layered defense, enhancing the overall safety and reliability of the agentic AI system.

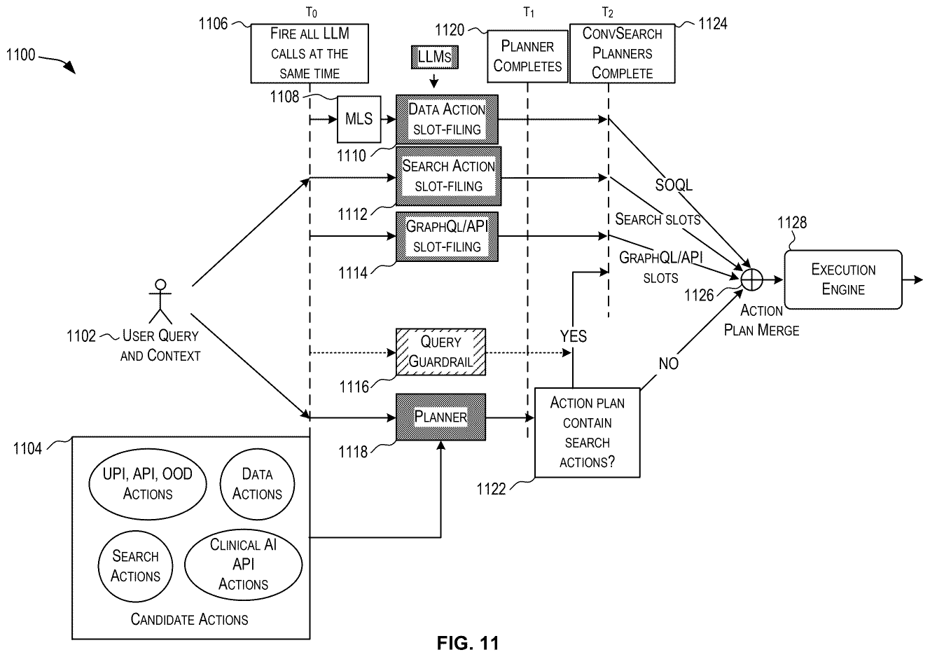

FIG. 11 is a block diagram illustrating operational aspects of a parallel execution planner 1100 of an agentic AI system. In some implementations, the parallel execution planner 1100 can be configured to provide increased accuracy and reduced latency relative to a single execution planner by employing multiple, concurrent processes for planning and safety analysis. The planner 1100 can receive a user query and context 1102 and, in response, a main planner 1118 can be configured to initiate a plurality of processes in parallel, as indicated by the operational step 1106 (“FIRE ALL LLM CALLS AT THE SAME TIME”). These parallel processes can include, but are not limited to, a query guardrail 1116, an meaning linking service (MLS) 1108 data slot-filling action 1110 for generating plan steps related to structured data, a search slot-filling action 1112 for generating plan steps related to unstructured data, and a GraphQL/API slot-filling action 1114 for generating plan steps related to other agent actions.

To provide further context for the parallel execution planner 1100, the agentic AI system, in some implementations, is configured as a multi-agent framework. In this framework, the main planner 1118 acts as an orchestrator, determining which specialized agent or agents are best suited to handle the user query 1102. The execution plan, therefore, can include steps to be executed by one or more of these agents. These can include, but are not limited to: a Data Agent configured to handle tasks related to structured data (e.g., EHR tables), a Search Agent configured to handle tasks related to unstructured data (e.g., free-text clinical notes), and a Clinical AI API Agent configured to handle other agent actions, such as more complex, predefined queries. As shown in FIG. 11, the tasks for these agents are initiated in parallel, corresponding to the MLS data slot-filling action 1110, the search slot-filling action 1112, and the GraphQL/API slot-filling action 1114, respectively.

Additionally, or alternatively, each of the specialized planning processes can receive a set of candidate actions 1104 to inform its operation. For example, the MLS data slot-filling action 1110 can receive candidate data actions, the search slot-filling action 1112 can receive candidate search actions, and the GraphQL/API slot-filling action 1114 can receive candidate actions from sources such as a Unified Primary Interface (UPI), an Application Programming Interface (API), or an Out-of-Domain (OOD) action set. The query guardrail 1116 can be configured to perform a safety analysis process on the user query and context 1102 to determine a safety classification. The main planner 1118 can be a lightweight planner primarily responsible for determining the overall structure of the execution plan, including the routing of actions to be performed by an action execution engine 1128, while the other parallel processes 1110, 1112, 1114 are specialized for more complex, domain-specific planning tasks.

In some implementations, the parallel execution planner 1100 can be configured to employ a time-based operational flow to optimize for latency. The lightweight main planner 1118 can be configured to complete its processing at a first time, T1 1120. At this point, a determination 1122 can be made as to whether the execution plan generated by the main planner 1104 requires outputs from the other, more complex planners (e.g., whether the plan contains search plan slots or structured query language slots). If the determination 1122 is negative, indicating a simpler query, the system can proceed directly to a plan merge step 1126 without waiting for the other planners to complete, thereby providing a low-latency path. If the determination 1118 is positive, indicating a more complex query, the system can wait until a second, later time, T2 1124, for the specialized planners 1110, 1112, 1114 to complete their processing.

The outputs from all completed planner processes can then be combined at the plan merge step 1126 to form a final, comprehensive execution plan. This merged plan can then be provided to the action execution engine 1128 for execution. The safety classification determined by the query guardrail 1116 can be used to authorize or block the action execution engine 1128 from carrying out the merged execution plan. This architecture allows the safety analysis to be performed in parallel with the planning processes, thereby minimizing or eliminating the latency overhead associated with the safety framework.

The agentic AI system can further include a response engine, such as the response generator 716 of FIG. 7 or the response engine 1010 of FIG. 10, which can be configured to receive one or more execution outputs from an execution engine, such as the execution engine 350 of FIG. 3, the execution engine 414 of FIG. 4, the execution engine 1008 of FIG. 10, or the action execution engine 1126 of FIG. 11. In some implementations, the response engine can be configured to synthesize the execution outputs from a plurality of agent actions into a single, cohesive response. The response engine can receive the execution outputs from all routed actions at once and can utilize one or more artificial intelligence models to generate a response that selects and combines relevant information from each of the execution outputs. Additionally, the response engine can be configured to perform one or more post-processing steps on a generated response before it is transmitted to a user, including a grounding verification process to check for factual consistency and an output guardrail process to analyze the response for compliance with safety and privacy policies.

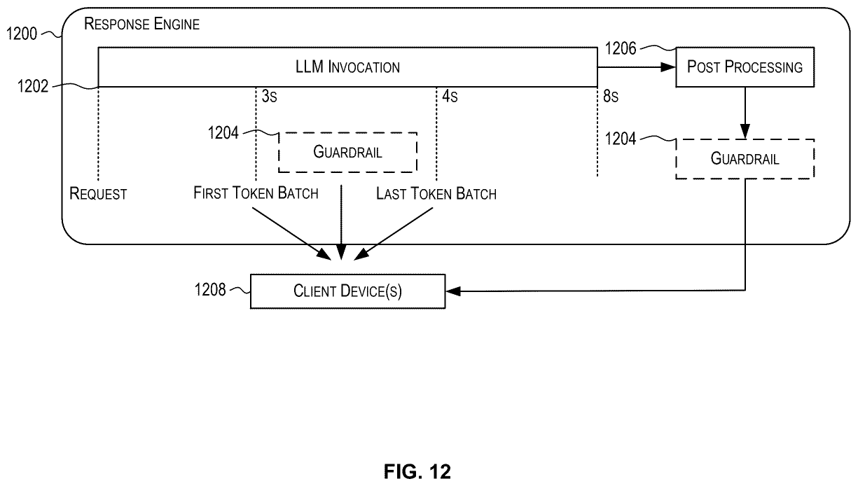

FIG. 12 shows a simplified block diagram of an example architecture for a response engine 1200 that includes a streaming guardrail framework. The architecture can include an LLM invocation component 1202, a post-processing component 1206, and a guardrail component 1204. This architecture can be configured to perform safety analysis on a response as it is being generated and streamed. In operation, upon receiving a request, the LLM invocation component 1202 can begin generating the response as a stream of data batches, starting with a first token batch. This batch can be immediately passed to the post-processing component 1206, where the guardrail component 1204 can perform a real-time safety analysis. If compliant, the batch is transmitted to the client device(s) 1208. This process can be repeated for subsequent token batches until the last token batch is processed. By analyzing the response in batches as it is being streamed, this architecture can avoid the significant latency that would be incurred by waiting for the entire response to be fully generated before initiating a safety check, thereby preserving a real-time, interactive user experience.

Additionally, or alternatively, the safety analysis performed by the guardrail component 1204 on the streaming token batches can constitute a first, lightweight phase of a multi-phase output safety check, with a second, more comprehensive check performed on the fully generated response after the last token batch is processed. To structure and format the content that is streamed and checked, the response engine 1200 can be configured to employ at least two distinct mechanisms: the Abstractive, Extractive, and Related (AER) format and the Conversation Message Model (CMM). The AER format is a structured JSON object used for AI-generated narrative responses, which separates the response into an abstractive section containing the narrative with inline annotations, and an extractive section that maps these annotations to their source data records. This allows a client device to render an interactive response where every fact can be traced to its source.

The multi-phase output safety check mentioned above provides a layered approach to ensuring response compliance while managing latency. The first output safety check, performed on the streaming data packets or token batches, may be a lightweight, real-time analysis. In some embodiments, this lightweight check is optimized for speed and is configured to detect readily identifiable policy violations. Such checks can include, for example, scanning for predefined keywords, filtering for profanity, identifying patterns that may correspond to protected health information (PHI) or personally identifiable information (PII), or detecting other specific linguistic markers that can be assessed with low computational overhead.

In contrast, the second output safety check, which is performed after the substantive response has been fully generated and assembled, may be a more comprehensive and computationally intensive analysis. This second check can be configured to evaluate the holistic quality and safety of the complete response. For example, the second check may assess the contextual appropriateness of the entire message, perform a factual consistency or grounding verification against the source data from which the response was synthesized, or analyze the response for compliance with more complex or nuanced policies that cannot be effectively evaluated on a batch-by-batch basis. In some implementations, during the streaming and lightweight checking phase, the generated token batches are held in an internal buffer. No portion of the response is transmitted or rendered to the client device 1208 until the full response is assembled and has successfully passed both the initial lightweight checks and the final comprehensive check. This buffering mechanism prevents a scenario where a partially generated, and potentially unsafe, response is displayed to a user, thereby ensuring a higher level of safety and reliability.

In other implementations, the response engine 1200 can utilize the Conversation Message Model (CMM), which is a declarative schema for defining rich, multi-modal user interface components such as tables or forms. The CMM approach uses a predefined response message configuration to transform raw execution output directly into a structured CMM message, avoiding the use of an artificial intelligence model for formatting and thereby eliminating the risk of formatting hallucinations. The response message configuration can specify a messageType and use an expression language to define precise data extraction and formatting rules. A client device receiving a CMM message can act as a deterministic renderer, interpreting the schema to construct the user interface exactly as specified. This provides for a high degree of reliability and control over the final presentation of structured data.

In some implementations, the system may be configured to combine signals from the query-side and response-side guardrails to create a more holistic and dynamic safety framework. The safety classification determined by the query guardrail component 1006 can be used to modulate the behavior of the output guardrail process in the response engine 1200. For example, a user query that is not blocked but is flagged by the query guardrail as being borderline or having a low-confidence score for a potential policy violation may cause the response engine to apply a more stringent set of safety policies during the generation and analysis of the response. This allows the system to dynamically adjust its safety posture based on the perceived risk of the entire user-system interaction, providing an additional layer of protection.

While some embodiments may utilize a large-scale LLM for the safety analysis process to achieve high accuracy, other embodiments may employ alternative model architectures to optimize for different performance characteristics. For example, the guardrail component 1006, and particularly the lightweight checks performed by the response engine guardrail 1204, may be implemented using smaller, fine-tuned classification models, such as BERT-style local models. Such models may offer lower latency, which can be advantageous in time-sensitive operations, while still providing effective detection for specific, well-defined policy violations.

Furthermore, alternative user experiences for the streaming response guardrail may be implemented. In an alternative to the buffering mechanism described above, the system may be configured to transmit and display the stream of data packets to the client device 1208 in real-time. In this configuration, if the guardrail component 1204 subsequently determines that a portion of the generated response violates a policy, the system can be configured to dynamically update the user interface to suppress, alter, or retract the already-displayed content. This approach presents a different method for balancing real-time interactivity with safety and compliance.

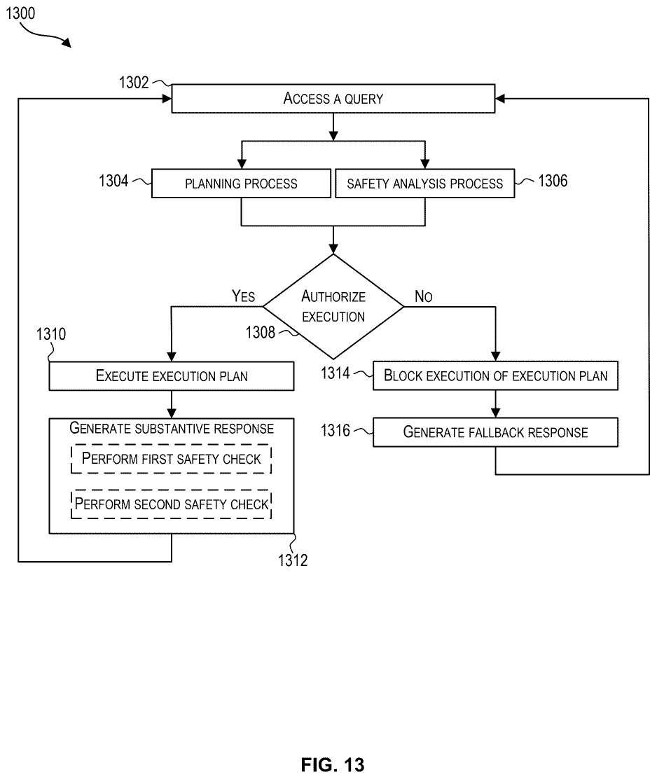

FIG. 13 depicts an example of a process 1300 for providing a low-latency safety framework for an agentic AI system. The process depicted in FIG. 13 may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process shown in FIG. 13 and described below is intended to be illustrative and non-limiting. Although FIG. 13 depicts the various steps occurring in a particular sequence or order, this is not intended to be limiting. In certain alternative embodiments, the steps may be performed in some different order, or some steps may be performed in parallel. In certain embodiments, such as in the embodiments depicted in FIGS. 5-7, the process shown FIG. 13 may be performed by the cloud service provider platform 514.

At block 1302, a query is accessed. The query, which can be the user query 1002 shown in FIG. 10, can be received and stored by a platform such as the cloud service provider platform 514 shown in FIGS. 5-7. In some implementations, the query is accessed from a storage device included in the platform. In some implementations, the query can be received from a client device such as the client device 510 shown in FIGS. 5-7. In some implementations, the query serves as an initial input that triggers the process flow.

At blocks 1304 and 1306, in response to accessing the query, a planning process and a safety analysis process can be initiated. The planning process and the safety analysis process can be initiated concurrently. In some implementations, the planning process and the safety analysis process can be initiated sequentially (e.g., initiating the planning process prior to initiating the safety analysis process or initiating the safety analysis process prior to initiating the planning process). As shown in FIG. 10, this parallel operation involves initiating a planning process to generate an execution plan for responding to the query; and a safety analysis process to determine a safety classification for the query based on a set of policies.

In some implementations, the planning process generates an execution plan for responding to the query. The execution plan includes at least one step for retrieving data from a confidential data source.

In some implementations, the safety analysis process determines a safety classification for the query based on a set of policies. In some implementations, the safety analysis process determines a confidence score associated with the safety classification. In some implementations, the confidence score can be used to modulate a policy of a safety check.

The set of policies can correspond to a predetermined operational domain, and the safety classification can be determined based on an interpretation of the query within a context of the predetermined operational domain. Additionally, or alternatively, the set of policies can correspond to a clinical operational domain, and the safety classification can be determined based on an interpretation of the query within a context of the clinical operational domain. In some implementations, the set of policies includes rules for identifying unethical queries relating to at least one of: fraudulent billing, patient data misuse, or discrimination in care.

In some implementations, the safety analysis process determines the safety classification by applying the set of policies in a hierarchical order. The hierarchical order can include assessing whether the query is unethical prior to assessing whether the query is unsafe and assessing whether the query is unsafe prior to assessing whether the query is out-of-domain. In some implementations, hierarchical order can include assessing whether the query is unsafe prior to assessing whether the query is unethical and assessing whether the query is out-of-domain prior to assessing whether the query is unethical or unsafe. The foregoing is not intended to be limiting, and the assessments can be made in other orders.

In some implementations, the safety analysis process includes generating a prompt for a machine learning model, and receiving, from the machine learning model, the safety classification for the query. The prompt can include the query and the set of policies, and the safety classification can be determined based on an evaluation of the query against the set of policies included in the prompt. In this way, an “LLM-as-a-judge” framework that provides a robust and adaptable mechanism for performing classification in complex domains can be provided.

At block 1308, a determination is made as to whether to authorize execution. In some implementations, this determination functions as a control gate, corresponding to the intervention point referenced above with respect to FIG. 10, which is logically positioned to precede the execution process and manage the authorization of actions.

In response to determining to authorize execution of the execution plan, at block 1310, the execution plan can be executed by an execution engine, such as the execution engine 1008 of FIG. 10, which carries out the step or steps defined in the execution plan and can include retrieving and synthesizing information from one or more data sources.

At block 1312, a substantive response to the query can be generated. The substantive response to the query can be generated in response to executing the execution plan. In some implementations, the substantive response can be generated dynamically as a data stream. For example, in some implementations, generating substantive response includes generating a stream of data packets, performing a first output safety check on at least one data packet of the stream of data packets as the stream of data packets is being generated, a second output safety check on the stream of data packets after the stream of data packets have been generated, or a combination thereof. In this way, a multi-phase output check can be performed in real-time. In some implementations, the substantive response can be transmitted to the client device 510. After transmitting the substantive response, the process can return to block 1302 where another query can be accessed. In some implementations, the query can be the next turn in a dialogue.

To create a more adaptive and integrated safety framework, signals from the input and output guardrails can be combined. In some implementations, a confidence score associated with the safety classification from the safety analysis process can be used to modulate a policy of the first output safety check or the second output safety check. For example, a user query that is not blocked but is flagged with a low-confidence score for a potential violation may cause the response engine to apply a more stringent set of safety policies during its output analysis.

In response to determining to not to authorize execution of the execution plan, at block 1314, execution of the execution plan can be blocked. In some implementations, blocking the execution of the execution plan prevents the at least one step of the execution plan from being performed.

At block 1316, after blocking execution of the execution plan, a fallback response can be generated. In some implementations, the fallback response is a templated response indicating that the query cannot be processed. In some implementations, the fallback response provides a consistent user experience in line with the fallback mechanisms discussed in connection with FIG. 9. In some implementations, the fallback response can be transmitted to the client device 510. After transmitting the fallback response, the process can return to block 1302 where another query can be accessed. In some implementations, the query can be the next turn in a dialogue.

### Examples of Cloud Infrastructure Architectures

The term cloud service is generally used to refer to a service that is made available by a cloud service provider (CSP) to users (e.g., cloud service customers) on demand (e.g., via a subscription model) using systems and infrastructure (cloud infrastructure) provided by the CSP. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including IaaS, software as a service (Saas), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 14 is a block diagram 1400 illustrating an example pattern of an IaaS architecture, according to at least one embodiment. Service operators 1402 can be communicatively coupled to a secure host tenancy 1404 that can include a virtual cloud network (VCN) 1406 and a secure host subnet 1408. In some examples, the service operators 1402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1406 and/or the Internet.

The VCN 1406 can include a local peering gateway (LPG) 1410 that can be communicatively coupled to a secure shell (SSH) VCN 1412 via an LPG 1410 contained in the SSH VCN 1412. The SSH VCN 1412 can include an SSH subnet 1414, and the SSH VCN 1412 can be communicatively coupled to a control plane VCN 1416 via the LPG 1410 contained in the control plane VCN 1416. Also, the SSH VCN 1412 can be communicatively coupled to a data plane VCN 1418 via an LPG 1410. The control plane VCN 1416 and the data plane VCN 1418 can be contained in a service tenancy 1419 that can be owned and/or operated by the IaaS provider.

The control plane VCN 1416 can include a control plane demilitarized zone (DMZ) tier 1420 that acts as a perimeter network (e.g., portions of a corporate network between the corporate intranet and external networks). The DMZ-based servers may have restricted responsibilities and help keep breaches contained. Additionally, the DMZ tier 1420 can include one or more load balancer (LB) subnet(s) 1422, a control plane app tier 1424 that can include app subnet(s) 1426, a control plane data tier 1428 that can include database (DB) subnet(s) 1430 (e.g. frontend DB subnet(s) and/or backend DB subnet(s)). The LB subnet(s) 1422 contained in the control plane DMZ tier 1420 can be communicatively coupled to the app subnet(s) 1426 contained in the control plane app tier 1424 and an Internet gateway 1434 that can be contained in the control plane VCN 1416, and the app subnet(s) 1426 can be communicatively coupled to the DB subnet(s) 1430 contained in the control plane data tier 1428 and a service gateway 1436 and a network address translation (NAT) gateway 1438. The control plane VCN 1416 can include the service gateway 1436 and the NAT gateway 1438.

The control plane VCN 1416 can include a data plane mirror app tier 1440 that can include app subnet(s) 1426. The app subnet(s) 1426 contained in the data plane mirror app tier 1440 can include a virtual network interface controller (VNIC) 1442 that can execute a compute instance 1444. The compute instance 1444 can communicatively couple the app subnet(s) 1426 of the data plane mirror app tier 1440 to app subnet(s) 1426 that can be contained in a data plane app tier 1446.

The data plane VCN 1418 can include the data plane app tier 1446, a data plane DMZ tier 1448, and a data plane data tier 1450. The data plane DMZ tier 1448 can include LB subnet(s) 1422 that can be communicatively coupled to the app subnet(s) 1426 of the data plane app tier 1446 and the Internet gateway 1434 of the data plane VCN 1418. The app subnet(s) 1426 can be communicatively coupled to the service gateway 1436 of the data plane VCN 1418 and the NAT gateway 1438 of the data plane VCN 1418. The data plane data tier 1450 can also include the DB subnet(s) 1430 that can be communicatively coupled to the app subnet(s) 1426 of the data plane app tier 1446.

The Internet gateway 1434 of the control plane VCN 1416 and of the data plane VCN 1418 can be communicatively coupled to a metadata management service 1452 that can be communicatively coupled to public Internet 1454. Public Internet 1454 can be communicatively coupled to the NAT gateway 1438 of the control plane VCN 1416 and of the data plane VCN 1418. The service gateway 1436 of the control plane VCN 1416 and of the data plane VCN 1418 can be communicatively coupled to cloud services 1456.

In some examples, the service gateway 1436 of the control plane VCN 1416 or of the data plane VCN 1418 can make application programming interface (API) calls to cloud services 1456 without going through public Internet 1454. The API calls to cloud services 1456 from the service gateway 1436 can be one-way: the service gateway 1436 can make API calls to cloud services 1456, and cloud services 1456 can send requested data to the service gateway 1436. But, cloud services 1456 may not initiate API calls to the service gateway 1436.

In some examples, the secure host tenancy 1404 can be directly connected to the service tenancy 1419, which may be otherwise isolated. The secure host subnet 1408 can communicate with the SSH subnet 1414 through an LPG 1410 that may enable two-way communication over an otherwise isolated system. Connecting the secure host subnet 1408 to the SSH subnet 1414 may give the secure host subnet 1408 access to other entities within the service tenancy 1419.

The control plane VCN 1416 may allow users of the service tenancy 1419 to set up or otherwise provision desired resources. Desired resources provisioned in the control plane VCN 1416 may be deployed or otherwise used in the data plane VCN 1418. In some examples, the control plane VCN 1416 can be isolated from the data plane VCN 1418, and the data plane mirror app tier 1440 of the control plane VCN 1416 can communicate with the data plane app tier 1446 of the data plane VCN 1418 via VNICs 1442 that can be contained in the data plane mirror app tier 1440 and the data plane app tier 1446.

In some examples, users of the system, or customers, can make requests, for example create, read, update, or delete (CRUD) operations, through public Internet 1454 that can communicate the requests to the metadata management service 1452. The metadata management service 1452 can communicate the request to the control plane VCN 1416 through the Internet gateway 1434. The request can be received by the LB subnet(s) 1422 contained in the control plane DMZ tier 1420. The LB subnet(s) 1422 may determine that the request is valid, and in response to this determination, the LB subnet(s) 1422 can transmit the request to app subnet(s) 1426 contained in the control plane app tier 1424. If the request is validated and requires a call to public Internet 1454, the call to public Internet 1454 may be transmitted to the NAT gateway 1438 that can make the call to public Internet 1454. Metadata that may be desired to be stored by the request can be stored in the DB subnet(s) 1430.

In some examples, the data plane mirror app tier 1440 can facilitate direct communication between the control plane VCN 1416 and the data plane VCN 1418. For example, changes, updates, or other suitable modifications to configuration may be desired to be applied to the resources contained in the data plane VCN 1418. Via a VNIC 1442, the control plane VCN 1416 can directly communicate with, and can thereby execute the changes, updates, or other suitable modifications to configuration to, resources contained in the data plane VCN 1418.

In some embodiments, the control plane VCN 1416 and the data plane VCN 1418 can be contained in the service tenancy 1419. In this case, the user, or the customer, of the system may not own or operate either the control plane VCN 1416 or the data plane VCN 1418. Instead, the IaaS provider may own or operate the control plane VCN 1416 and the data plane VCN 1418, both of which may be contained in the service tenancy 1419. This embodiment can enable isolation of networks that may prevent users or customers from interacting with other users,’ or other customers,’ resources. Also, this embodiment may allow users or customers of the system to store databases privately without needing to rely on public Internet 1454, which may not have a desired level of threat prevention, for storage.

In other embodiments, the LB subnet(s) 1422 contained in the control plane VCN 1416 can be configured to receive a signal from the service gateway 1436. In this embodiment, the control plane VCN 1416 and the data plane VCN 1418 may be configured to be called by a customer of the IaaS provider without calling public Internet 1454. Customers of the IaaS provider may desire this embodiment since database(s) that the customers use may be controlled by the IaaS provider and may be stored on the service tenancy 1419, which may be isolated from public Internet 1454.

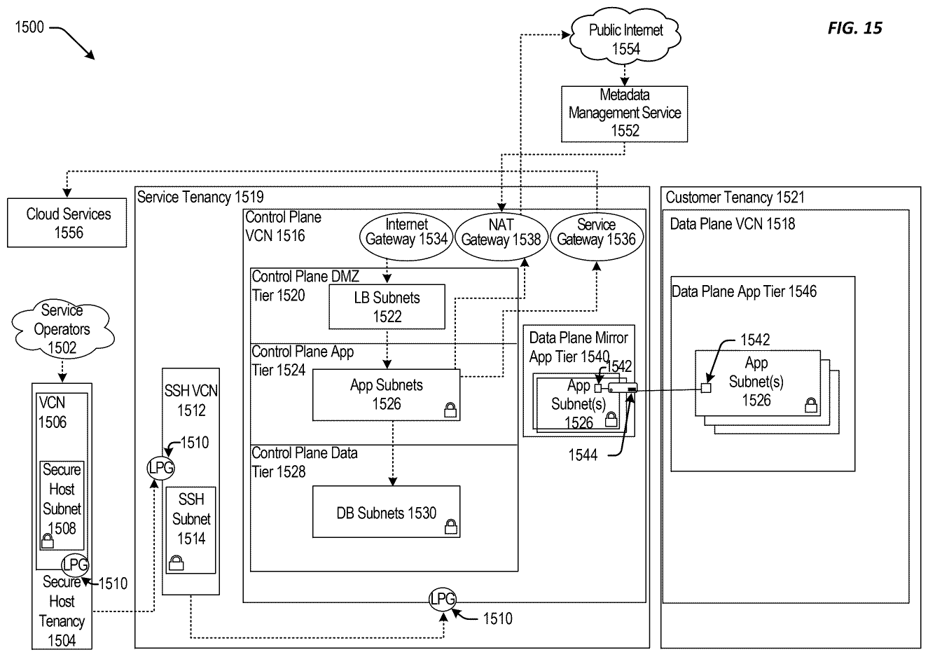

FIG. 15 is a block diagram 1500 illustrating another example pattern of an IaaS architecture, according to at least one embodiment. Service operators 1502 (e.g., service operators 1402 of FIG. 14) can be communicatively coupled to a secure host tenancy 1504 (e.g., the secure host tenancy 1404 of FIG. 14) that can include a virtual cloud network (VCN) 1506 (e.g., the VCN 1406 of FIG. 14) and a secure host subnet 1508 (e.g., the secure host subnet 1408 of FIG. 14). The VCN 1506 can include a local peering gateway (LPG) 1510 (e.g., the LPG 1410 of FIG. 14) that can be communicatively coupled to a secure shell (SSH) VCN 1512 (e.g., the SSH VCN 1412 of FIG. 14) via an LPG 1410 contained in the SSH VCN 1512. The SSH VCN 1512 can include an SSH subnet 1514 (e.g., the SSH subnet 1414 of FIG. 14), and the SSH VCN 1512 can be communicatively coupled to a control plane VCN 1516 (e.g., the control plane VCN 1416 of FIG. 14) via an LPG 1510 contained in the control plane VCN 1516. The control plane VCN 1516 can be contained in a service tenancy 1519 (e.g., the service tenancy 1419 of FIG. 14), and the data plane VCN 1518 (e.g., the data plane VCN 1418 of FIG. 14) can be contained in a customer tenancy 1521 that may be owned or operated by users, or customers, of the system.

The control plane VCN 1516 can include a control plane DMZ tier 1520 (e.g., the control plane DMZ tier 1420 of FIG. 14) that can include LB subnet(s) 1522 (e.g., LB subnet(s) 1422 of FIG. 14), a control plane app tier 1524 (e.g., the control plane app tier 1424 of FIG. 14) that can include app subnet(s) 1526 (e.g., app subnet(s) 1426 of FIG. 14), a control plane data tier 1528 (e.g., the control plane data tier 1428 of FIG. 14) that can include database (DB) subnet(s) 1530 (e.g., similar to DB subnet(s) 1430 of FIG. 14). The LB subnet(s) 1522 contained in the control plane DMZ tier 1520 can be communicatively coupled to the app subnet(s) 1526 contained in the control plane app tier 1524 and an Internet gateway 1534 (e.g., the Internet gateway 1434 of FIG. 14) that can be contained in the control plane VCN 1516, and the app subnet(s) 1526 can be communicatively coupled to the DB subnet(s) 1530 contained in the control plane data tier 1528 and a service gateway 1536 (e.g., the service gateway 1436 of FIG. 14) and a network address translation (NAT) gateway 1538 (e.g., the NAT gateway 1438 of FIG. 14). The control plane VCN 1516 can include the service gateway 1536 and the NAT gateway 1538.

The control plane VCN 1516 can include a data plane mirror app tier 1540 (e.g., the data plane mirror app tier 1440 of FIG. 14) that can include app subnet(s) 1526. The app subnet(s) 1526 contained in the data plane mirror app tier 1540 can include a virtual network interface controller (VNIC) 1542 (e.g., the VNIC of 1442) that can execute a compute instance 1544 (e.g., similar to the compute instance 1444 of FIG. 14). The compute instance 1544 can facilitate communication between the app subnet(s) 1526 of the data plane mirror app tier 1540 and the app subnet(s) 1526 that can be contained in a data plane app tier 1546 (e.g., the data plane app tier 1446 of FIG. 14) via the VNIC 1542 contained in the data plane mirror app tier 1540 and the VNIC 1542 contained in the data plane app tier 1546.

The Internet gateway 1534 contained in the control plane VCN 1516 can be communicatively coupled to a metadata management service 1552 (e.g., the metadata management service 1452 of FIG. 14) that can be communicatively coupled to public Internet 1554 (e.g., public Internet 1454 of FIG. 14). Public Internet 1554 can be communicatively coupled to the NAT gateway 1538 contained in the control plane VCN 1516. The service gateway 1536 contained in the control plane VCN 1516 can be communicatively coupled to cloud services 1556 (e.g., cloud services 1456 of FIG. 14).

In some examples, the data plane VCN 1518 can be contained in the customer tenancy 1521. In this case, the IaaS provider may provide the control plane VCN 1516 for each customer, and the IaaS provider may, for each customer, set up a unique compute instance 1544 that is contained in the service tenancy 1519. Each compute instance 1544 may allow communication between the control plane VCN 1516, contained in the service tenancy 1519, and the data plane VCN 1518 that is contained in the customer tenancy 1521. The compute instance 1544 may allow resources, that are provisioned in the control plane VCN 1516 that is contained in the service tenancy 1519, to be deployed or otherwise used in the data plane VCN 1518 that is contained in the customer tenancy 1521.

In other examples, the customer of the IaaS provider may have databases that live in the customer tenancy 1521. In this example, the control plane VCN 1516 can include the data plane mirror app tier 1540 that can include app subnet(s) 1526. The data plane mirror app tier 1540 can reside in the data plane VCN 1518, but the data plane mirror app tier 1540 may not live in the data plane VCN 1518. That is, the data plane mirror app tier 1540 may have access to the customer tenancy 1521, but the data plane mirror app tier 1540 may not exist in the data plane VCN 1518 or be owned or operated by the customer of the IaaS provider. The data plane mirror app tier 1540 may be configured to make calls to the data plane VCN 1518 but may not be configured to make calls to any entity contained in the control plane VCN 1516. The customer may desire to deploy or otherwise use resources in the data plane VCN 1518 that are provisioned in the control plane VCN 1516, and the data plane mirror app tier 1540 can facilitate the desired deployment, or other usage of resources, of the customer.

In some embodiments, the customer of the IaaS provider can apply filters to the data plane VCN 1518. In this embodiment, the customer can determine what the data plane VCN 1518 can access, and the customer may restrict access to public Internet 1554 from the data plane VCN 1518. The IaaS provider may not be able to apply filters or otherwise control access of the data plane VCN 1518 to any outside networks or databases. Applying filters and controls by the customer onto the data plane VCN 1518, contained in the customer tenancy 1521, can help isolate the data plane VCN 1518 from other customers and from public Internet 1554.

In some embodiments, cloud services 1556 can be called by the service gateway 1536 to access services that may not exist on public Internet 1554, on the control plane VCN 1516, or on the data plane VCN 1518. The connection between cloud services 1556 and the control plane VCN 1516 or the data plane VCN 1518 may not be live or continuous. Cloud services 1556 may exist on a different network owned or operated by the IaaS provider. Cloud services 1556 may be configured to receive calls from the service gateway 1536 and may be configured to not receive calls from public Internet 1554. Some cloud services 1556 may be isolated from other cloud services 1556, and the control plane VCN 1516 may be isolated from cloud services 1556 that may not be in the same region as the control plane VCN 1516. For example, the control plane VCN 1516 may be located in “Region 1,” and cloud service “Deployment 14,” may be located in Region 1 and in “Region 2.” If a call to Deployment 14 is made by the service gateway 1536 contained in the control plane VCN 1516 located in Region 1, the call may be transmitted to Deployment 14 in Region 1. In this example, the control plane VCN 1516, or Deployment 14 in Region 1, may not be communicatively coupled to, or otherwise in communication with, Deployment 14 in Region 2.

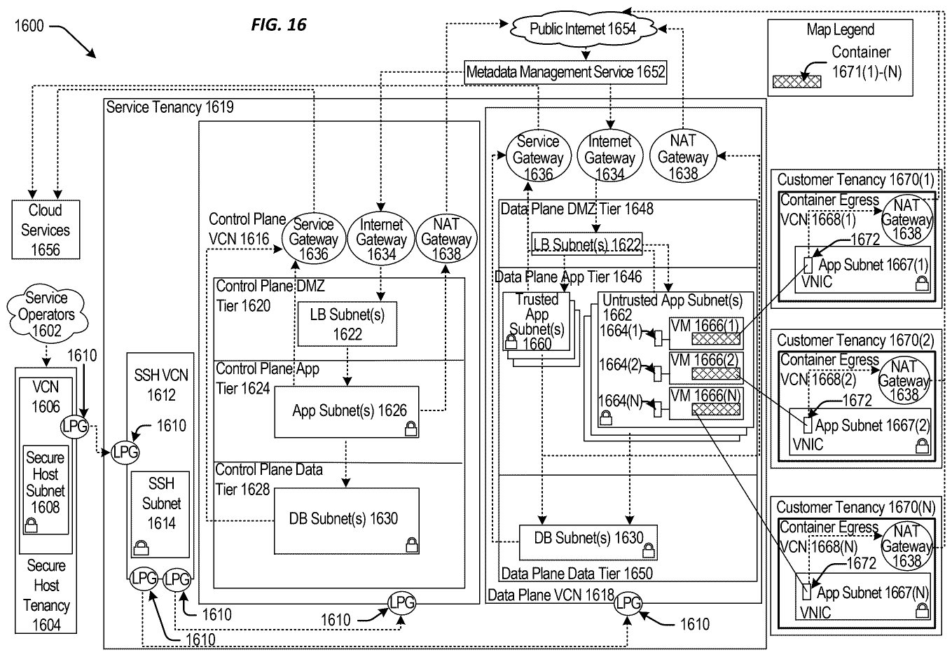

FIG. 16 is a block diagram 1600 illustrating another example pattern of an IaaS architecture, according to at least one embodiment. Service operators 1602 (e.g., service operators 1402 of FIG. 14) can be communicatively coupled to a secure host tenancy 1604 (e.g., the secure host tenancy 1404 of FIG. 14) that can include a virtual cloud network (VCN) 1606 (e.g., the VCN 1406 of FIG. 14) and a secure host subnet 1608 (e.g., the secure host subnet 1408 of FIG. 14). The VCN 1606 can include an LPG 1610 (e.g., the LPG 1410 of FIG. 14) that can be communicatively coupled to an SSH VCN 1612 (e.g., the SSH VCN 1412 of FIG. 14) via an LPG 1610 contained in the SSH VCN 1612. The SSH VCN 1612 can include an SSH subnet 1614 (e.g., the SSH subnet 1414 of FIG. 14), and the SSH VCN 1612 can be communicatively coupled to a control plane VCN 1616 (e.g., the control plane VCN 1416 of FIG. 14) via an LPG 1610 contained in the control plane VCN 1616 and to a data plane VCN 1618 (e.g., the data plane 1418 of FIG. 14) via an LPG 1610 contained in the data plane VCN 1618. The control plane VCN 1616 and the data plane VCN 1618 can be contained in a service tenancy 1619 (e.g., the service tenancy 1419 of FIG. 14).

The control plane VCN 1616 can include a control plane DMZ tier 1620 (e.g., the control plane DMZ tier 1420 of FIG. 14) that can include load balancer (LB) subnet(s) 1622 (e.g., LB subnet(s) 1422 of FIG. 14), a control plane app tier 1624 (e.g., the control plane app tier 1424 of FIG. 14) that can include app subnet(s) 1626 (e.g., similar to app subnet(s) 1426 of FIG. 14), a control plane data tier 1628 (e.g., the control plane data tier 1428 of FIG. 14) that can include DB subnet(s) 1630. The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1434 of FIG. 14) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 14) and a network address translation (NAT) gateway 1638 (e.g., the NAT gateway 1438 of FIG. 14). The control plane VCN 1616 can include the service gateway 1636 and the NAT gateway 1638.

The data plane VCN 1618 can include a data plane app tier 1646 (e.g., the data plane app tier 1446 of FIG. 14), a data plane DMZ tier 1648 (e.g., the data plane DMZ tier 1448 of FIG. 14), and a data plane data tier 1650 (e.g., the data plane data tier 1450 of FIG. 14). The data plane DMZ tier 1648 can include LB subnet(s) 1622 that can be communicatively coupled to trusted app subnet(s) 1660 and untrusted app subnet(s) 1662 of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include one or more primary VNICs 1664(1)-(N) that can be communicatively coupled to tenant virtual machines (VMs) 1666(1)-(N). Each tenant VM 1666(1)-(N) can be communicatively coupled to a respective app subnet 1667(1)-(N) that can be contained in respective container egress VCNs 1668(1)-(N) that can be contained in respective customer tenancies 1670(1)-(N). Respective secondary VNICs 1672(1)-(N) can facilitate communication between the untrusted app subnet(s) 1662 contained in the data plane VCN 1618 and the app subnet contained in the container egress VCNs 1668(1)-(N). Each container egress VCNs 1668(1)-(N) can include a NAT gateway 1638 that can be communicatively coupled to public Internet 1654 (e.g., public Internet 1454 of FIG. 14).

The Internet gateway 1634 contained in the control plane VCN 1616 and contained in the data plane VCN 1618 can be communicatively coupled to a metadata management service 1652 (e.g., the metadata management system 1452 of FIG. 14) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some embodiments, the data plane VCN 1618 can be integrated with customer tenancies 1670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1646.

Code to run the function may be executed in the VMs 1666(1)-(N), and the code may not be configured to run anywhere else on the data plane VCN 1618. Each VM 1666(1)-(N) may be connected to one customer tenancy 1670. Respective containers 1671(1)-(N) contained in the VMs 1666(1)-(N) may be configured to run the code. In this case, there can be a dual isolation (e.g., the containers 1671(1)-(N) running code, where the containers 1671(1)-(N) may be contained in at least the VM 1666(1)-(N) that are contained in the untrusted app subnet(s) 1662), which may help prevent incorrect or otherwise undesirable code from damaging the network of the IaaS provider or from damaging a network of a different customer. The containers 1671(1)-(N) may be communicatively coupled to the customer tenancy 1670 and may be configured to transmit or receive data from the customer tenancy 1670. The containers 1671(1)-(N) may not be configured to transmit or receive data from any other entity in the data plane VCN 1618. Upon completion of running the code, the IaaS provider may kill or otherwise dispose of the containers 1671(1)-(N).

In some embodiments, the trusted app subnet(s) 1660 may run code that may be owned or operated by the IaaS provider. In this embodiment, the trusted app subnet(s) 1660 may be communicatively coupled to the DB subnet(s) 1630 and be configured to execute CRUD operations in the DB subnet(s) 1630. The untrusted app subnet(s) 1662 may be communicatively coupled to the DB subnet(s) 1630, but in this embodiment, the untrusted app subnet(s) may be configured to execute read operations in the DB subnet(s) 1630. The containers 1671(1)-(N) that can be contained in the VM 1666(1)-(N) of each customer and that may run code from the customer may not be communicatively coupled with the DB subnet(s) 1630.

In other embodiments, the control plane VCN 1616 and the data plane VCN 1618 may not be directly communicatively coupled. In this embodiment, there may be no direct communication between the control plane VCN 1616 and the data plane VCN 1618. However, communication can occur indirectly through at least one method. An LPG 1610 may be established by the IaaS provider that can facilitate communication between the control plane VCN 1616 and the data plane VCN 1618. In another example, the control plane VCN 1616 or the data plane VCN 1618 can make a call to cloud services 1656 via the service gateway 1636. For example, a call to cloud services 1656 from the control plane VCN 1616 can include a request for a service that can communicate with the data plane VCN 1618.

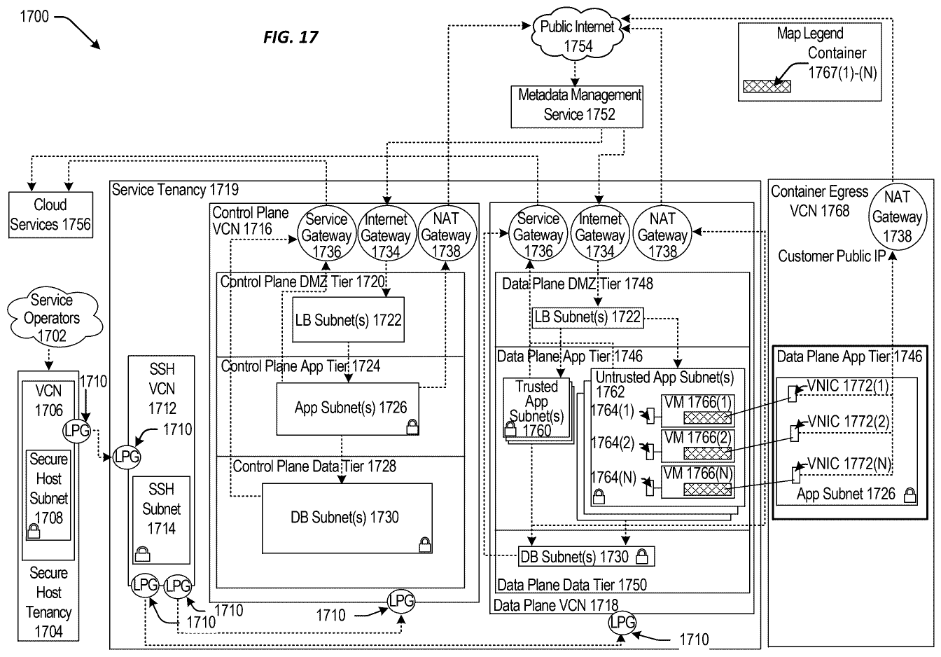

FIG. 17 is a block diagram 1700 illustrating another example pattern of an IaaS architecture, according to at least one embodiment. Service operators 1702 (e.g., service operators 1402 of FIG. 14) can be communicatively coupled to a secure host tenancy 1704 (e.g., the secure host tenancy 1404 of FIG. 14) that can include a virtual cloud network (VCN) 1706 (e.g., the VCN 1406 of FIG. 14) and a secure host subnet 1708 (e.g., the secure host subnet 1408 of FIG. 14). The VCN 1706 can include an LPG 1710 (e.g., the LPG 1410 of FIG. 14) that can be communicatively coupled to an SSH VCN 1712 (e.g., the SSH VCN 1412 of FIG. 14) via an LPG 1710 contained in the SSH VCN 1712. The SSH VCN 1712 can include an SSH subnet 1714 (e.g., the SSH subnet 1414 of FIG. 14), and the SSH VCN 1712 can be communicatively coupled to a control plane VCN 1716 (e.g., the control plane VCN 1416 of FIG. 14) via an LPG 1710 contained in the control plane VCN 1716 and to a data plane VCN 1718 (e.g., the data plane 1418 of FIG. 14) via an LPG 1710 contained in the data plane VCN 1718. The control plane VCN 1716 and the data plane VCN 1718 can be contained in a service tenancy 1719 (e.g., the service tenancy 1419 of FIG. 14).

The control plane VCN 1716 can include a control plane DMZ tier 1720 (e.g., the control plane DMZ tier 1420 of FIG. 14) that can include LB subnet(s) 1722 (e.g., LB subnet(s) 1422 of FIG. 14), a control plane app tier 1724 (e.g., the control plane app tier 1424 of FIG. 14) that can include app subnet(s) 1726 (e.g., app subnet(s) 1426 of FIG. 14), a control plane data tier 1728 (e.g., the control plane data tier 1428 of FIG. 14) that can include DB subnet(s) 1730 (e.g., DB subnet(s) 1630 of FIG. 16). The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1434 of FIG. 14) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 14) and a network address translation (NAT) gateway 1738 (e.g., the NAT gateway 1438 of FIG. 14). The control plane VCN 1716 can include the service gateway 1736 and the NAT gateway 1738.

The data plane VCN 1718 can include a data plane app tier 1746 (e.g., the data plane app tier 1446 of FIG. 14), a data plane DMZ tier 1748 (e.g., the data plane DMZ tier 1448 of FIG. 14), and a data plane data tier 1750 (e.g., the data plane data tier 1450 of FIG. 14). The data plane DMZ tier 1748 can include LB subnet(s) 1722 that can be communicatively coupled to trusted app subnet(s) 1760 (e.g., trusted app subnet(s) 1660 of FIG. 16) and untrusted app subnet(s) 1762 (e.g., untrusted app subnet(s) 1662 of FIG. 16) of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include primary VNICs 1764(1)-(N) that can be communicatively coupled to tenant virtual machines (VMs) 1766(1)-(N) residing within the untrusted app subnet(s) 1762. Each tenant VM 1766(1)-(N) can run code in a respective container 1767(1)-(N), and be communicatively coupled to an app subnet 1726 that can be contained in a data plane app tier 1746 that can be contained in a container egress VCN 1768. Respective secondary VNICs 1772(1)-(N) can facilitate communication between the untrusted app subnet(s) 1762 contained in the data plane VCN 1718 and the app subnet contained in the container egress VCN 1768. The container egress VCN can include a NAT gateway 1738 that can be communicatively coupled to public Internet 1754 (e.g., public Internet 1454 of FIG. 14).

The Internet gateway 1734 contained in the control plane VCN 1716 and contained in the data plane VCN 1718 can be communicatively coupled to a metadata management service 1752 (e.g., the metadata management system 1452 of FIG. 14) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively coupled to cloud services 1756.

In some examples, the pattern illustrated by the architecture of block diagram 1700 of FIG. 17 may be considered an exception to the pattern illustrated by the architecture of block diagram 1600 of FIG. 16 and may be desirable for a customer of the IaaS provider if the IaaS provider cannot directly communicate with the customer (e.g., a disconnected region). The respective containers 1767(1)-(N) that are contained in the VMs 1766(1)-(N) for each customer can be accessed in real-time by the customer. The containers 1767(1)-(N) may be configured to make calls to respective secondary VNICs 1772(1)-(N) contained in app subnet(s) 1726 of the data plane app tier 1746 that can be contained in the container egress VCN 1768. The secondary VNICs 1772(1)-(N) can transmit the calls to the NAT gateway 1738 that may transmit the calls to public Internet 1754. In this example, the containers 1767(1)-(N) that can be accessed in real-time by the customer can be isolated from the control plane VCN 1716 and can be isolated from other entities contained in the data plane VCN 1718. The containers 1767(1)-(N) may also be isolated from resources from other customers.

In other examples, the customer can use the containers 1767(1)-(N) to call cloud services 1756. In this example, the customer may run code in the containers 1767(1)-(N) that requests a service from cloud services 1756. The containers 1767(1)-(N) can transmit this request to the secondary VNICs 1772(1)-(N) that can transmit the request to the NAT gateway that can transmit the request to public Internet 1754. Public Internet 1754 can transmit the request to LB subnet(s) 1722 contained in the control plane VCN 1716 via the Internet gateway 1734. In response to determining the request is valid, the LB subnet(s) can transmit the request to app subnet(s) 1726 that can transmit the request to cloud services 1756 via the service gateway 1736.

It should be appreciated that IaaS architectures 1400, 1500, 1600, 1700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

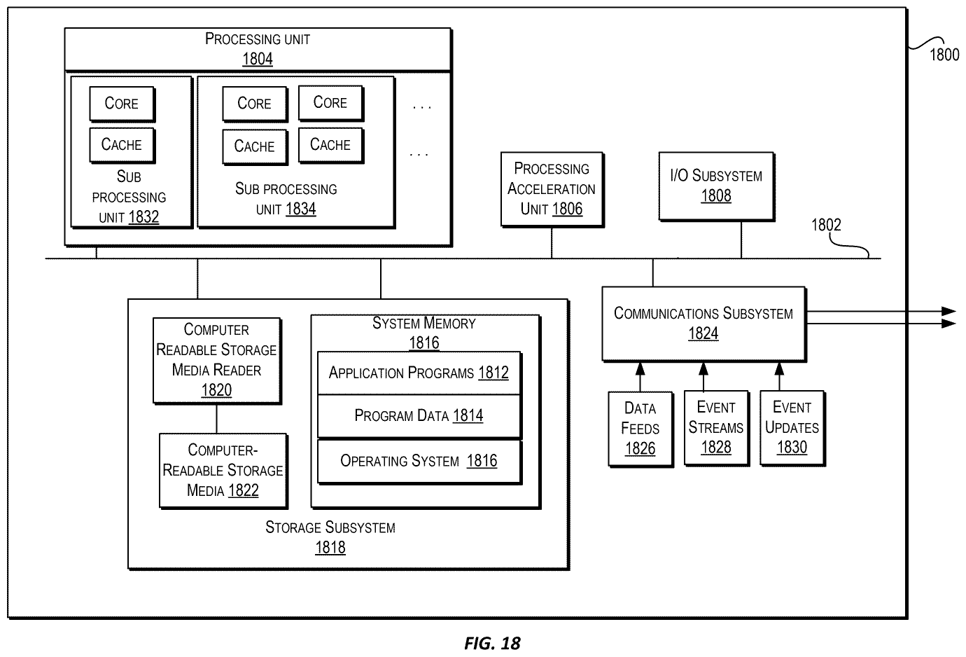

FIG. 18 illustrates an example computer system 1800, in which various embodiments may be implemented. The system 1800 may be used to implement any of the computer systems described above. As shown in the figure, computer system 1800 includes a processing unit 1804 that communicates with a number of peripheral subsystems via a bus subsystem 1802. These peripheral subsystems may include a processing acceleration unit 1806, an I/O subsystem 1808, a storage subsystem 1818 and a communications subsystem 1824. Storage subsystem 1818 includes tangible computer-readable storage media 1822 and a system memory 1810.

Bus subsystem 1802 provides a mechanism for letting the various components and subsystems of computer system 1800 communicate with each other as intended. Although bus subsystem 1802 is shown schematically as a single bus, alternative embodiments of the bus subsystem may utilize multiple buses. Bus subsystem 1802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1804, which can be implemented as one or more integrated circuits (e.g., a conventional microprocessor or microcontroller), controls the operation of computer system 1800. One or more processors may be included in processing unit 1804. These processors may include single core or multicore processors. In certain embodiments, processing unit 1804 may be implemented as one or more independent processing units 1832 and/or 1834 with single or multicore processors included in each processing unit. In other embodiments, processing unit 1804 may also be implemented as a quad-core processing unit formed by integrating two dual-core processors into a single chip.

In various embodiments, processing unit 1804 can execute a variety of programs in response to program code and can maintain multiple concurrently executing programs or processes. At any given time, some or all of the program code to be executed can be resident in processor(s) 1804 and/or in storage subsystem 1818. Through suitable programming, processor(s) 1804 can provide various functionalities described above. Computer system 1800 may additionally include a processing acceleration unit 1806, which can include a digital signal processor (DSP), a special-purpose processor, and/or the like.

I/O subsystem 1808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1800 may comprise a storage subsystem 1818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1804 provide the functionality described above. Storage subsystem 1818 may also provide a repository for storing data used in accordance with the present disclosure.

As depicted in the example in FIG. 18, storage subsystem 1818 can include various components including a system memory 1810, computer-readable storage media 1822, and a computer readable storage media reader 1820. System memory 1810 may store program instructions that are loadable and executable by processing unit 1804. System memory 1810 may also store data that is used during the execution of the instructions and/or data that is generated during the execution of the program instructions. Various different kinds of programs may be loaded into system memory 1810 including but not limited to client applications, Web browsers, mid-tier applications, relational database management systems (RDBMS), virtual machines, containers, etc.

System memory 1810 may also store an operating system 1816. Examples of operating system 1816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1800 executes one or more virtual machines, the virtual machines along with their guest operating systems (GOSs) may be loaded into system memory 1810 and executed by one or more processors or cores of processing unit 1804.

System memory 1810 can come in different configurations depending upon the type of computer system 1800. For example, system memory 1810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1810 may include a basic input/output system (BIOS) containing basic routines that help to transfer information between elements within computer system 1800, such as during start-up.

Computer-readable storage media 1822 may represent remote, local, fixed, and/or removable storage devices plus storage media for temporarily and/or more permanently containing, storing, computer-readable information for use by computer system 1800 including instructions executable by processing unit 1804 of computer system 1800.

Computer-readable storage media 1822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1822 may include, but is not limited to, Zip® drives, flash memory cards, universal serial bus (USB) flash drives, secure digital (SD) cards, DVD disks, digital video tape, and the like. Computer-readable storage media 1822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1800.

Machine-readable instructions executable by one or more processors or cores of processing unit 1804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1824 provides an interface to other computer systems and networks. Communications subsystem 1824 serves as an interface for receiving data from and transmitting data to other systems from computer system 1800. For example, communications subsystem 1824 may enable computer system 1800 to connect to one or more devices via the Internet. In some embodiments communications subsystem 1824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1824 can provide wired network connectivity (e.g., Ethernet) in addition to or instead of a wireless interface.

In some embodiments, communications subsystem 1824 may also receive input communication in the form of structured and/or unstructured data feeds 1826, event streams 1828, event updates 1830, and the like on behalf of one or more users who may use computer system 1800.

By way of example, communications subsystem 1824 may be configured to receive data feeds 1826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1824 may also be configured to receive data in the form of continuous data streams, which may include event streams 1828 of real-time events and/or event updates 1830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1824 may also be configured to output the structured and/or unstructured data feeds 1826, event streams 1828, event updates 1830, and the like to one or more databases that may be in communication with one or more streaming data source computers coupled to computer system 1800.

Computer system 1800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing a query;
in response to accessing the query, initiating:
a planning process to generate an execution plan for responding to the query; and
a safety analysis process to determine a safety classification for the query based on a set of policies;
determining, based on the safety classification from the safety analysis process, whether to authorize execution of the execution plan; and
in response to determining to authorize execution of the execution plan, executing the execution plan and generating a substantive response for the query based on execution of the execution plan.

2. The computer-implemented method of claim 1, wherein the planning process and the safety analysis process are initiated to run concurrently.

3. The computer-implemented method of claim 1, further comprising:
in response to determining not to authorize execution of the execution plan, blocking the execution of the execution plan and generating a fallback response.

4. The computer-implemented method of claim 3, wherein the fallback response is a templated response indicating that the query cannot be processed.

5. The computer-implemented method of claim 1, wherein the safety analysis process determines the safety classification by applying the set of policies in a hierarchical order.

6. The computer-implemented method of claim 5, wherein the hierarchical order comprises assessing whether the query is unethical prior to assessing whether the query is unsafe, and assessing whether the query is unsafe prior to assessing whether the query is out-of-domain.

7. The computer-implemented method of claim 1, wherein the set of policies corresponds to a predetermined operational domain, and wherein the safety classification is determined based on an interpretation of the query within a context of the predetermined operational domain.

8. The computer-implemented method of claim 1, wherein the execution plan comprises at least one step for retrieving data from a confidential data source, and wherein blocking the execution of the execution plan prevents the at least one step from being performed.

9. The computer-implemented method of claim 1, wherein generating the substantive response comprises generating a stream of data packets.

10. The computer-implemented method of claim 9, wherein generating the substantive response comprises performing a first output safety check on at least one data packet of the stream of data packets as the stream of data packets is being generated, a second output safety check on the stream of data packets after the stream of data packets have been generated, or a combination thereof.

11. The computer-implemented method of claim 10, wherein a confidence score associated with the safety classification from the safety analysis process is used to modulate a policy of the first output safety check or the second output safety check.

12. The computer-implemented method of claim 1, wherein the safety analysis process comprises:
generating a prompt for a machine learning model, the prompt including the query and the set of policies; and
receiving, from the machine learning model, the safety classification for the query based on an evaluation of the query against the set of policies included in the prompt.

13. The computer-implemented method of claim 1, wherein the set of policies corresponds to a clinical operational domain, and wherein the set of policies includes rules for identifying unethical queries relating to at least one of: fraudulent billing, patient data misuse, or discrimination in care.

14. A system comprising:
one or more processors; and
one or more computer-readable media storing instructions which, when executed by the one or more processors, cause the system to perform operations comprising:
accessing a query;
in response to accessing the query, initiating:
a planning process to generate an execution plan for responding to the query; and
a safety analysis process to determine a safety classification for the query based on a set of policies;
determining, based on the safety classification from the safety analysis process, whether to authorize execution of the execution plan; and
in response to determining to authorize execution of the execution plan, executing the execution plan and generating a substantive response for the query based on execution of the execution plan.

15. The system of claim 14, the operations further comprising:
in response to determining not to authorize execution of the execution plan, blocking the execution of the execution plan and generating a fallback response.

16. The system of claim 15, wherein the fallback response is a templated response indicating that the query cannot be processed.

17. The system of claim 14, wherein the safety analysis process comprises:
generating a prompt for a machine learning model, the prompt including the query and the set of policies; and
receiving, from the machine learning model, the safety classification for the query based on an evaluation of the query against the set of policies included in the prompt.

18. One or more non-transitory computer-readable media storing instructions which, when executed by one or more processors, cause a system to perform operations comprising:
accessing a query;
in response to accessing the query, initiating:
a planning process to generate an execution plan for responding to the query; and
a safety analysis process to determine a safety classification for the query based on a set of policies;
determining, based on the safety classification from the safety analysis process, whether to authorize execution of the execution plan; and
in response to determining to authorize execution of the execution plan, executing the execution plan and generating a substantive response for the query based on execution of the execution plan.

19. The one or more non-transitory computer-readable media of claim 18, wherein the set of policies corresponds to a predetermined operational domain, and wherein the safety classification is determined based on an interpretation of the query within a context of the predetermined operational domain.

20. The one or more non-transitory computer-readable media of claim 18, wherein the execution plan comprises at least one step for retrieving data from a confidential data source, and wherein blocking the execution of the execution plan prevents the at least one step from being performed.
